(19) United States
(12) Patent Application Publication
(10) Pub. No.: US 2021/0117980 A1
(43) Pub. Date: Apr. 22, 2021

(54) WIRED OR WIRELESS INTEGRATED BIOMETRIC AUTHENTICATION TERMINAL HAVING MULTIPLE SAFETY LOCK FUNCTION AND ADVERTISEMENT METHOD USING THE SAME

(71) Applicant: ALL IT TOP CO., LTD., SEOUL (KR)

(72) Inventors: Sung Ho CHOI, Uiwang-si (KR); Chung Ja SONG, Uiwang-si (KR); Dae Jin PARK, Seoul (KR); Woo Kyoum KIM, Jinju-si (KR)

(21) Appl. No.: 16/608,310

(22) PCT Filed: Apr. 23, 2018
(86) PCT No.: PCT/KR2018/004661

§ 371 Date: Oct. 25, 2019

(30) Foreign Application Priority Data
Apr. 25, 2017 (KR) 10-2017-0052807
Apr. 28, 2017 (KR) 10-2017-0054962

(51) Int. Cl. G06Q 20/40; G06Q 20/20; G06Q 20/38; G06Q 30/02; G06K 9/00

(52) U.S. Cl. CPC G06Q 20/40145; G06Q 20/204; G06Q 20/382; G06K 2009/0006; G06K 9/00013; G06K 9/001; G06Q 30/0268

(57) ABSTRACT

A wireless/wired integrated biometric authentication terminal having a multiple safety lock function is provided. A customer payment system is formed in an electronic cover of the integrated biometric authentication terminal. The electronic cover has at least one of a fingerprint and finger vein authentication processing unit formed on one side, as a groove on which a finger can be put, to interoperate with the customer payment system of the POS terminal and a card information authentication processing unit formed on the other side and configured to interoperate with the customer payment system of the POS terminal to perform authentication processing on payment with a customer's card information. A customer LCD display unit for displaying a payment amount is formed on an upper front end of the electronic cover.

### CROSS-REFERENCE TO RELATED APPLICATIONS

This application claims priority to PCT Application No. PCT/KR2018/004661, having a filing date of Apr. 23, 2018, which is based upon and claims priority to KR Application No. 10-2017-0054962, having a filing date of Apr. 28, 2017 and KR Application No. 10-2017-0052807, having a filing date of Apr. 25, 2017, the entire contents of all priority documents are incorporated herein by reference.

### FIELD OF TECHNOLOGY

The following relates to a wired or wireless integrated biometric authentication terminal having a multiple safety lock function and an advertisement method using the same, and more specifically, to an electronic payment terminal according to a wired or wireless integrated device having a multiple safety lock function in cooperation with a financial transaction relay linked to biometric authentication and an advertisement method using the same.

In particular, the following relates to a wired or wireless integrated biometric authentication terminal having a multiple safety lock function, the wired or wireless integrated biometric authentication terminal characterized in that an ID photo 1810a interoperating with a fingerprint is displayed on a customer liquid crystal display (LCD) display 1199a and/or a clerk LCD display 130 for the purpose of identity verification at the time of payment with a finger through a fingerprint and/or finger vein authentication processing unit 1180.

Also, embodiments of the present invention relates to an authentication card (including a smartphone card) and a terminal capable of being used by authenticating a fingerprint, that is, an electronic payment terminal according to a wired or wireless integrated device having a multiple safety lock function in cooperation with a financial transaction relay linked to biometric authentication capable of identity verification by using a fingerprint and finger vein authentication device or by using, as the authentication card, a convergence card that displays photographic information through an LCD interoperating with fingerprint recognition that cannot be used without a user's fingerprint or without a user's human body information even if the card is lost.

### BACKGROUND

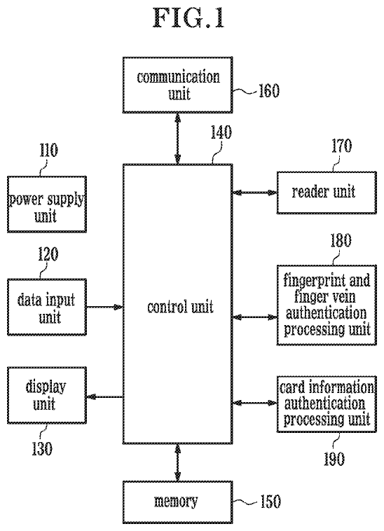

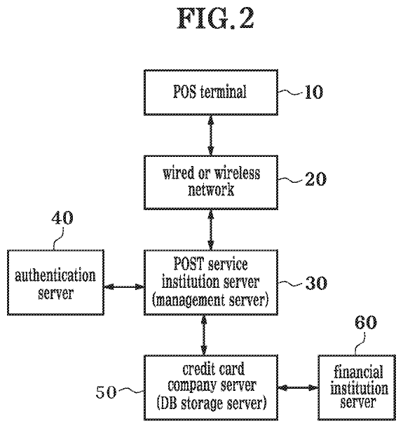

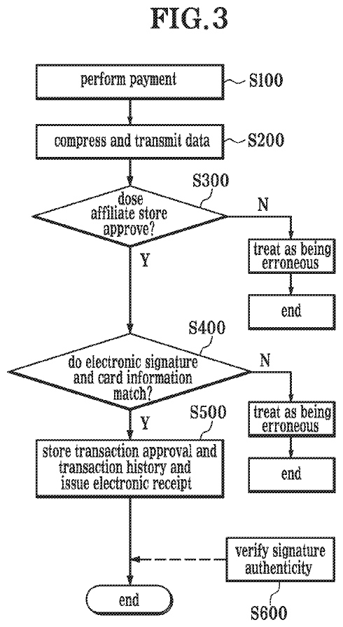

As described in Korean Patent Publication No. 10-2004-0053810 as a conventional invention, FIG. 1 is a block diagram showing the whole system applied to the conventional invention, FIG. 2 is a block diagram illustrating a payment method using a point-of-sale (POS) terminal according to the present invention, and FIG. 3 is a flowchart schematically showing a configuration of an integrated payment device using a POS terminal of the conventional invention.

As shown, embodiments of the present invention roughly includes a POS terminal 10, a POS service institution server (a management server) 30, a credit card company server (a data storage server) 50, a financial institution server 60, and an authentication server 40.

The POS terminal 10 is connected to the POS service institution server 30 through a wired or wireless network 20 formed as a dedicated network such as a high-speed communication network, and the authentication server 40 is separately connected to the POS service institution server 30.

The POS terminal 10 is a dedicated terminal for using the credit card company server 50. Affiliate store information is registered in a credit card company such that the POS terminal 10 is issued with a unique terminal ID and configured to exchange certificates with the authentication server 40.

In the case of embodiments of the invention, furthermore, the POS terminal 10 of the affiliate store has a background image unique to the affiliate store, and the background image is shared with the servers and thus can be used to authenticate the affiliate store.

The credit card company server 50 is connected to the POS service institution server 30, and the credit card company server 50 is connected to the financial institution server 60 for checking a card state and a user's electronic signature.

Also, the credit card company server 50 is utilized as a data storage server for storing transaction details.

In the above configuration, the POS terminal 10 stores a seed value assigned by the authentication server 40, encrypts information to be transmitted, and transmits the encrypted information, and the terminal 10 and the authentication server 40 exchange certificates using a modified secure socket layer (SSL) protocol.

Also, the terminal 10 also receives electronic signature data from a user through a signature input unit by means of a stylus pen. The data input through the signature input unit and affiliate store information or transaction detail information are compressed to text and vector data upon payment and then transmitted to the POS service institution server 30 over a dedicated network.

First, a user visits a credit card affiliate store, purchases a product or service, and then makes a payment using a credit card through a POS terminal. In this case, the payment is processed by entering the credit card into the terminal.

In this case, a first process of storing transaction detail information generated when a user purchases a product, that is, a product name, a quantity, a price, a transaction date, a transaction manager, and affiliate store information, i.e., the ID of an affiliate store terminal and the ID of a background image in the POS terminal along with a user's electronic signature and then entering credit card information of the user, that is, a card number and a card expiration date upon payment, is performed (S100).

In this case, it will be appreciated that the above process may be performed by using a terminal supporting both a card contact type (an existing method) and a contactless type (radio-frequency identification (RFID), etc.) or by selectively using any one of the two types if necessary.

Next, a second process of compressing the entered information into text and vector data and then transmitting the text and vector data to the POS service institution server over a dedicated network is performed (S200). In this process, only corresponding ID information is transmitted, and the background image is excluded from the transmission. When IDs match each other, the background image is shared with the servers.

Accordingly, in the case of embodiments of the present invention, each transaction requires a storage capacity of about two kilobytes because transaction-related information and credit card information are less than one kilobyte and signature vector information is also less than one kilobyte. Therefore, it is possible to maximize the utilization of storage space as well as to reduce network traffic load.

Also, a third process of transmitting the transmitted affiliate store information to the authentication server connected to the POS service institution server to determine whether the affiliate store is authenticated, treating the process as being erroneous and then terminating the process when the authentication fails, and transmitting an encrypted seed value to the corresponding POS terminal when the authentication is successful, wherein the corresponding terminal encrypts a signature stored based on a transmitted seed value by means of an encryption module and then transmits the signature and related information to the credit card company server is performed (S300).

A fourth process of determining whether the transmitted electronic signature and card information of the user match an electronic signature and card information pre-registered in the financial institution server, treating the process as being erroneous and terminating the process when the transmitted electronic signature does not match the pre-registered electronic signature or when the transmitted card information does not match the pre-registered card information, and requesting transaction approval from the financial institution server when the transmitted electronic signature matches the pre-registered electronic signature and the transmitted card information matches the pre-registered card information, that is, when the card state is normal, is performed (S400).

A fifth process of transmitting an approval number for a transaction normally processed during the above process to the POS terminal, storing transaction details in the credit card company server, and transmitting information for issuing an electronic receipt to the POS terminal upon the user's request is performed (S500).

Also, the price of the product purchased in the above process is paid to the corresponding affiliate store through the credit card company, and the transaction is stored in the credit card company server utilized as the data storage server. Accordingly, the user may be issued with an electronic receipt corresponding to the transaction not immediately but only when necessary.

The embodiments may further include a sixth process of calculating a reliability level of a customer's signature and verifying the authenticity of the signature in case there is a claim for whether a signature payment is made after the user perform a payment (S600).

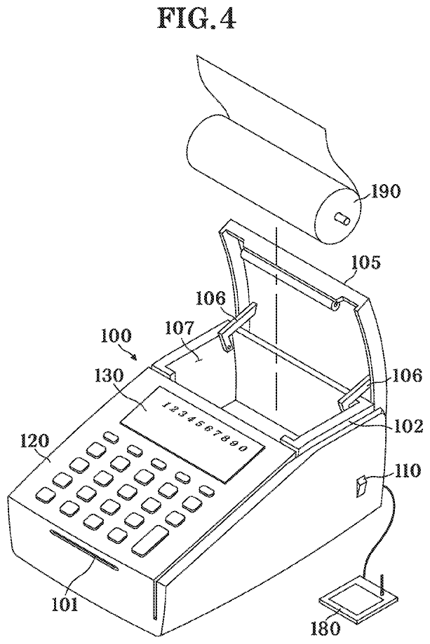

As shown in FIG. 4, a conventional POS terminal 100 disclosed in Korean Patent Publication No. 10-2013-0030028 has a printing paper storage lid 105, which is the lid of a printing paper storage unit 107 for storing a printing paper unit 190, formed in an upper portion by the main body and a hinging unit 106.

Also, the POS terminal 100 has a magnetic card check unit 102 formed on one side and an integrated circuit (IC) card check unit 101 formed in a lower portion. A payment amount is displayed on a liquid crystal display (LCD) display unit 130 through the data input unit 120, and the payment is made when a final payment button is pressed and a signature is input into a signature unit (a signature pad) 180.

However, such a type of payment using the POS terminal is made only through a formal signature procedure and a touch on the signature unit 180 and thus has many weak points in identity verification.

As shown, the POS terminal 100 includes a power supply unit 110, a data input unit 120, a display unit 130, a control unit 140, a memory 150, a communication unit 160, a reader unit 170, a signature unit 180, and a printing unit 190.

The power supply unit 110 supplies operating power to operate the device.

The data input unit 120 consists of a keyboard, a touch panel, and the like provided outside the device, and outputs, to the control unit 140, real-time information based on a workplace situation entered by a workplace manager.

The display unit 130 displays, on the screen, the real-time information entered through the data input unit 120. Also, the display unit 130 displays operating information (e.g.; sales information, etc.) related to sales at a typical workplace.

The control unit 140 performs control such that real-time information reflecting a business state of the workplace corresponding to an input operation of the workplace manager received through the data input unit 120 is stored in the memory 150 and performs control such that the real-time information is transmitted to an information management server computer 300 through the communication unit 160.

The memory 150 stores a control program for driving the POS terminal 100 and also stores real-time information entered by the workplace manager, cost payment information according to the use of the real-time information, settlement processing information of an accrued profit, and the like.

The communication unit 160 transmits real-time information directly entered by the workplace manager to the information management server computer 300 over a network communication network under the control of the control unit 140.

The reader unit 170 includes a scanner, a card reader, and the like, and recognizes discount information of the real-time information displayed on the user terminal 400 when a user who has visited the workplace pays a cost for the use of the workplace on the basis of the real-time information.

The signature unit 180 converts signature data entered by a user who performs a general card payment into digital data and outputs the digital data to the control unit 140.

The printing unit 190 outputs receipts provided to users who pay costs under the control of the control unit 140.

However, even credit cards do not require an identity verification procedure. Thus, although a credit card is lost and then used by any finder, the identity verification procedure cannot be performed.

Moreover, even though a video technique has been developed, face photo expression technology capable of using a fingerprint and a finger vein or an associated bankbook or card to confirm a user's identity has not been developed in conjunction with recognition of fingerprints and finger veins.

### SUMMARY

An aspect relates to a multiple safety lock function in which a security system based on an iris or face recognition and also a simultaneous authentication system based on a fingerprint and/or a finger vein for identity verification in place of an invalid signature unit or signature pad are implemented in one point-of-sale (POS) terminal wherein a product advertisement may be executed upon a customer's payment.

The embodiments are directed to displaying an ID photo 1810a interoperating with a fingerprint on a customer LCD display unit 1199a and/or a clerk LCD display unit 130 for the purpose of identity verification upon payment using a finger in a fingerprint and/or finger vein authentication processing unit 1180.

In particular, the biometric information includes a face, an iris, a voice, a fingerprint, a finger vein, and the like. However, even in the case of convergent recognition, an authentication method should be facilitated, and also identity verification based on real biometric information needs to be facilitated.

In addition, when a bankbook or bank card is called using a fingerprint, the fingerprint may not be unique, and there may be two or more fingerprints. In this case, another person's bankbook or card may be illegally used, and thus a method of blocking the illegal use should be provided.

Also, embodiments of the present invention is directed to finally allowing a payment based on biometric authentication by allowing a payment based on biometric authentication through the direct use of a card when a customer has the card and by allowing the selection of a bank and a card to be made through his or her biometric authentication when a customer has no card.

The embodiments are directed to eliminating a signature system based on paper of a printing paper unit so as to secure installation space for electronics and establishing a system for automatically delivering or storing a deposit and withdrawal history to or in a smartphone.

Also, embodiments of the present invention is directed to improving the security and reliability of an authenticity check for a card user when a task such as a cash withdrawal or a card payment is performed and is also directed to enhancing the accuracy and convenience of fingerprint recognition itself by installing fingerprint data in an authentication card itself and then allowing the fingerprint data to be used only after blood flow is detected upon recognition of a user's fingerprint.

That is, embodiments of the present invention is directed to providing an authentication system capable of preventing authentication when temperature and/or blood flow is not detected due to forgery, such as with silicone or the like.

Furthermore, in order to solve a general problem of not distinguishing card holders in a visual manner, embodiments of the present invention is directed to providing a method of registering a user's photo in a card memory (a smart chip) and displaying the photo on a liquid crystal display when fingerprints match so as to perform identity verification.

Also, embodiments of the present invention is directed to performing development in cooperation with fingerprint recognition for the purpose of security by displaying a photo image on a fingerprint card using a technique for a liquid crystal display or a flexible display.

The embodiments relate to a wired or wireless integrated terminal having a multiple safety lock function through biometric authentication, wherein the integrated terminal is a point-of-sale (POS) terminal 1000 which has a cuboid shape, which has a magnetic card check unit 1102 formed on one side and an integrated circuit (IC) card check unit 1101 formed in a lower portion, which starts when a power supply unit 1110 is turned on, and which displays a payment amount on a clerk liquid crystal display (LCD) display unit 1130 through a data input unit 1120 so that a final payment button is pushed, wherein an electronic cover 1150 usable only by a customer is formed on a front surface opposite to the clerk LCD display unit 1130 of the POS terminal 1000, wherein a customer payment system usable only by a customer who makes a payment is built in the electronic cover 1150, wherein in the customer payment system, the electronic cover 1150 has a fingerprint and finger vein authentication processing unit 1180 formed on one inner side and a card information authentication processing unit 1190 formed on the other side to process a customer's card information through a near field communication (NFC) transmission signal of a card to perform authentication processing with the customer's card information, wherein a customer LCD display unit for checking the payment amount is formed in a central portion of the electronic cover 1150.

Also, embodiments of the present invention relates to a wired or wireless integrated biometric authentication terminal having a multiple safety lock function, wherein the integrated biometric authentication terminal 1000a has a cuboid shape, is separately provided for financial transactions, and is connected to a point-of-sale (POS) terminal 100 in a wired or wireless manner, wherein the POS terminal 100 has a cuboid shape, has a magnetic card check unit 102 formed on one side and an integrated circuit (IC) card check unit 101 formed in a lower portion, starts when a power supply unit 110 is turned on, and displays a payment amount on a clerk LCD display unit 130 through a data input unit 120 so that a final payment button is pushed, wherein a customer payment system is formed in an electronic cover 1150 of the integrated biometric authentication terminal 1000a, wherein the electronic cover 1150 has a fingerprint and/or finger vein authentication processing unit 1180 formed on one side, as a groove on which a finger is to be put, to interoperate with the customer payment system of the POS terminal 100 and a card information authentication processing unit 1190 formed on the other side to process a customer's card information through a near field communication (NFC) transmission signal of a card to perform authentication processing on the payment with the customer's card information in cooperation with the customer payment system of the POS terminal 100, wherein a customer LCD display unit 1199a for displaying the payment amount is formed on an upper front end of the electronic cover 1150.

Also, according to embodiments of the present invention, the wired or wireless integrated terminal having the multiple safety lock function is characterized in that the customer LCD display unit is formed on the electronic cover 1150 to execute a three-second instant advertisement video upon payment with a fingerprint and/or a finger vein or upon payment with a card.

Also, according to embodiments of the present invention, the wired or wireless integrated biometric authentication terminal having the multiple safety lock function is characterized in that a password input button 1120a for a 10-digit number is formed in an upper portion of the electronic cover 1150 and used when a password is requested.

Also, according to embodiments of the present invention, the wired or wireless integrated biometric authentication terminal having the multiple safety lock function is characterized in that a usage amount confirmation button 1120b is formed on the electronic cover 1150 to display a usage amount confirmation table 3288 in which transaction amounts and financial transaction approval (cancellation) numbers are accumulated.

Also, according to embodiments of the present invention, the wired or wireless integrated biometric authentication terminal having the multiple safety lock function is characterized in that the customer LCD display unit is formed by a hinge such that angle adjustment is possible according to a customer's location wherein the electronic cover 1150 is also formed on a rear end of the main body by a hinge such that the electronic cover (1150) is rotatable along with the main body of the integrated biometric authentication terminal 1000a.

Also, according to embodiments of the present invention, the wired or wireless integrated biometric authentication terminal having the multiple safety lock function is characterized in that an ID photo 1810a interoperating with fingerprint and/or finger vein information is displayed on the customer LCD display unit 1199a and/or the customer LCD display unit 130 to perform identity verification upon payment with a finger in the fingerprint and/or finger vein authentication processing unit 1180.

Also, according to embodiments of the present invention, the wired or wireless integrated biometric authentication terminal having the multiple safety lock function is characterized in that the fingerprint and/or finger vein authentication processing unit 1180 is formed as a contact-type fingerprint scan module 2310 for the purpose of fingerprint recognition and has an empty finger capture groove 2410 formed thereunder such that a finger f is put on the empty finger capture groove 2410 for the purpose of finger vein recognition wherein an image sensor 2510a and an infrared transmission unit 2520a for capturing the finger f and a recognition circuit electronic unit for controlling the image sensor 2510a and the infrared transmission unit 2520a are formed in an authentication device unit space.

Also, according to embodiments of the present invention, the wired or wireless integrated biometric authentication terminal having the multiple safety lock function is characterized in that an optical-type recognition module is used instead of the contact-type fingerprint scan module wherein the optical-type recognition module is composed of an image sensor 2310a and an infrared transmission unit 2320a to capture an image by emitting infrared rays toward a fingerprint.

Also, according to embodiments of the present invention, the wired or wireless integrated biometric authentication terminal having the multiple safety lock function is characterized in that an integrated module U1 of the fingerprint and/or finger vein authentication processing unit 1180 for authenticating both a fingerprint and a finger vein is composed of a fingerprint scan module U2, a finger vein module U3, and a conversion module U4, wherein the fingerprint scan module U2 scans a fingerprint by means of an image sensor, compares an image obtained through the scanning to prestored images, and then outputs authentication code registered for a person corresponding to the finger image in 232 serial communication when the corresponding person is present, wherein the finger vein module U3 scans a finger vein by means of a camera image sensor after penetrating a finger with an infrared LED, compares an image obtained through the scanning to prestored finger vein images, and then outputs authentication code registered for a person corresponding to the finger vein image in 485 serial communication when the corresponding person is present, wherein the conversion module U4 receives the 485 serial communication output from the finger vein module, converts the 485 serial communication into the 232 serial communication, and outputs the 232-communication like the fingerprint module U2, wherein the integrated module U1 receives fingerprint authentication code output from the fingerprint module U2 and finger vein authentication code output from the finger vein module U3 and outputs one of the fingerprint authentication code and the finger vein authentication code through Universal Serial Bus (USB) or the integrated module U1 receives fingerprint authentication code output from the fingerprint module U2 and finger vein authentication code output from the finger vein module U3 and outputs corresponding authentication code through USB when the fingerprint authentication code matches the finger vein authentication code.

Also, according to embodiments of the present invention, the wired or wireless integrated biometric authentication terminal having the multiple safety lock function is characterized in that in the fingerprint scan module U2, GND line #1 indicates a (−) voltage circuit, RX line #2 indicates a serial data reception port, TX line #3 indicates a serial data transmission port, and VCC line #4 indicates a (+) voltage reference of a power supply circuit, wherein the lines are used to scan a fingerprint by means of an image sensor, compare an image obtained through the scanning to prestored images, and then output authentication code registered for a person corresponding to the finger image in serial communication when the corresponding person is present.

Also, according to embodiments of the present invention, the wired or wireless integrated biometric authentication terminal having the multiple safety lock function is characterized in that in the finger vein module U3, GND line #1 indicates a (−) voltage reference, A line #2 indicates a serial communication specification RS485-communication port A, B line #3 indicates a serial communication specification RS485-communication port B, and VCC line #4 indicates a (+) voltage reference of a power supply circuit, wherein on the left side of the conversion module U4, GND line #1 indicates a (−) voltage reference, A line #2 indicates a serial communication specification RS485-communication port A, B line #3 indicates a serial communication specification RS485-communication port B, and VCC line #4 indicates a (+) voltage reference, wherein on the right side of the conversion module U4 interoperating with the finger vein module U3, DI line #5 indicates a serial 232-communication reception port, RE line #6 indicates a 485-communication control port, DE line #7 indicates a 485-communication control port, and RO line #8 indicates a serial 232-communication transmission port.

Also, according to embodiments of the present invention, the wired or wireless integrated biometric authentication terminal having the multiple safety lock function is characterized in that the fingerprint and finger vein authentication processing unit 1180 receives fingerprint information from the integrated biometric authentication terminal 1000a upon connection of financial information for payment (a bankbook or card), performs primary user authentication using the fingerprint information, and then performs authentication processing by entering a user's phone number or processes user authentication using a user's account password, face information, or iris information when the fingerprint information is not unique and there are two pieces of the same fingerprint information.

Also, according to embodiments of the present invention, the wired or wireless integrated biometric authentication terminal having the multiple safety lock function is characterized in that the fingerprint and finger vein authentication processing unit 1180 includes a customer client connected to a communication network and configured to acquire a customer's fingerprint and/or finger vein information; an affiliate client connected to the communication network and configured to acquire the customer's fingerprint and/or finger vein information of the customer client when an e-commerce transaction occurs; and a fingerprint and/or finger vein payment service server configured to receive the fingerprint and/or finger vein information from the customer client through the communication network and register the fingerprint and/or finger vein information to correspond to a payment means or payment device or payment and configured to compare the fingerprint and/or finger vein information received from the customer client to fingerprint and/or finger vein information transmitted from the affiliate client upon the transmission of the fingerprint and/or finger vein information, perform authentication processing of the customer, and perform a payment through the payment means or payment device or payment corresponding to the fingerprint and/or finger vein information of the customer client.

Also, according to embodiments of the present invention, the wired or wireless integrated biometric authentication terminal having the multiple safety lock function is characterized in that when a result of comparing the registered fingerprint information of the customer client to newly received fingerprint information upon connection of financial information for payment (a bankbook or card) through the communication network is that the fingerprint information is not unique and there are two pieces of the same fingerprint information, authentication processing is performed by entering one of a user's phone number or a password, one piece of the financial information for payment is selected for the user, and then secondary user authentication is processed using face information.

Also, according to embodiments of the present invention, the wired or wireless integrated terminal having the multiple safety lock function is characterized in that an iris information authentication processing unit 1194 and/or a face information authentication processing unit 1196 are formed in an upper central portion of the customer LCD display unit.

Also, embodiments of the present invention relate to an advertisement method using a wired or wireless integrated terminal having a multiple safety lock function associated with an advertisement, wherein the advertisement method in which the three-second instant advertisement video is executed is an advertisement method using a point-of-sales (POS) terminal that has a customer LCD display unit formed on an electronic cover 1150 formed on a front surface of the POS terminal and that executes a three-second instant advertisement video upon payment with a fingerprint and/or a finger vein or upon payment with a card, the advertisement method including a step of turning on an advertisement switch of the POS terminal (S300); a thirty-second advertisement video step in which a general thirty-second short advertisement video is displayed on the customer LCD display unit 1199a; 1199b when the advertisement switch of the POS terminal is turned on (S301); a payment amount input step in which a payment amount is entered and then displayed on the customer LCD display unit (S302); a step of stopping the advertisement and displaying the payment on the customer LCD display unit when the payment amount is entered (S303); a payment amount informing step in which a customer is informed of payment methods using a voice (or text) (S304); a payment execution step in which the customer selects a payment method (human body information or card information) (S305); an advertisement execution step in which when a charged amount is paid, a three-second instant advertisement is executed (S306); and a payment completion step in which the payment is entirely complete (S307).

Also, according to embodiments of the present invention, the advertisement method further includes, after the advertisement execution step in which the three-second instant advertisement video is executed (S306), an advertisement video repeating step in which the three-second instant advertisement video is further executed when the customer touches the human body information or the card information once more (S308).

According to embodiments of the present invention, it is possible to perform a multiple safety lock function in which a security system based on iris or face recognition and also a simultaneous authentication system based on a fingerprint and/or a finger vein for identity verification in place of an invalid signature unit or signature pad are implemented in one POS terminal, and it is also possible to execute an advertisement upon payment.

Also, according to embodiments of the present invention, by displaying an ID photo 1810a interoperating with a fingerprint on a customer liquid crystal display (LCD) display unit 1199a and/or a clerk LCD display unit 130 for the purpose of identity verification upon payment with a finger in a fingerprint and/or finger vein authentication processing unit 1180, it is possible to obtain psychological stability about identity verification through payment with a finger and to solve anxiety about financial theft or the like in financial settlement.

In particular, the biometric information includes a face, an iris, a voice, a fingerprint, a finger vein, and the like. However, by employing a method of recognizing a fingerprint first and then recognizing face information later to initiate the procedure through the touch of a smartphone with a finger and capture a face with a camera of the smartphone while selecting a bankbook or card for payment to prepare to authenticate face information, it is possible to actually facilitate identity verification based on human body information.

In addition, when a bankbook or bank card is called using a fingerprint, the fingerprint may not be unique, and there may be two or more fingerprints. In this case, by entering a phone number or a password to select one of the fingerprints, it is possible to prevent another person's bankbook or card from being illegally used, and it is also possible to allow a financial transaction even when no bankbook or card is carried.

Also, it is possible to allow a payment based on biometric authentication through the direct use of a card when a customer has the card and also to allow the selection of a bank and a card to be made through his or her biometric authentication when a customer has no card. Finally, it is possible to allow a payment based on biometric authentication to maximize identity verification.

Also, by eliminating a signature system based on paper of a printing paper unit, it is possible to ensure an installation space of such an electronic device. By establishing a system for automatically delivering or storing a deposit and withdrawal history to or in a smartphone, it is possible to prevent unnecessary waste of paper, eliminate a collection work, and simplify identity verification through authentication based on fingerprint and/or finger vein, iris, and face.

Also, by installing fingerprint data in an authentication card itself and then allowing the fingerprint data to be used only after blood flow is detected upon recognition of a user's fingerprint, it is possible to improve the security and reliability of an authenticity check for a card user when a task such as a cash withdrawal or a card payment is performed.

In addition, by scanning the fingerprint recognition by means of a contact-type fingerprint authentication module, it is possible to reduce production cost due to a simple structure, an easy design, and the like.

Also, by preventing authentication when temperature and/or blood flow is not detected due to forgery, such as with silicone or the like, it is possible for an affiliate store to check the authenticity of a card user.

Furthermore, by registering a user's photo in a card memory unit (a smart chip) and displaying the photo on a liquid crystal display when fingerprints match, it is possible to provide an opportunity for identify verification and eliminate misusages when applied to an identification card or the like.

Also, by displaying a photo image on a fingerprint card using a technique for a liquid crystal display or a flexible display to perform identity verification, it is possible to enhance the identity verification.

### BRIEF DESCRIPTION

Some of the embodiments will be described in detail, with reference to the following figures, wherein like designations denote like members, wherein:

FIG. 1 is a block diagram showing a block diagram of the whole system;

FIG. 2 is a block diagram illustrating a price payment method using a point-of-sale (POS) terminal;

FIG. 3 is a flowchart schematically showing a configuration of an integrated payment device using the POS terminal;

FIG. 4 is a perspective view schematically showing the configuration of the integrated payment device using the POS terminal;

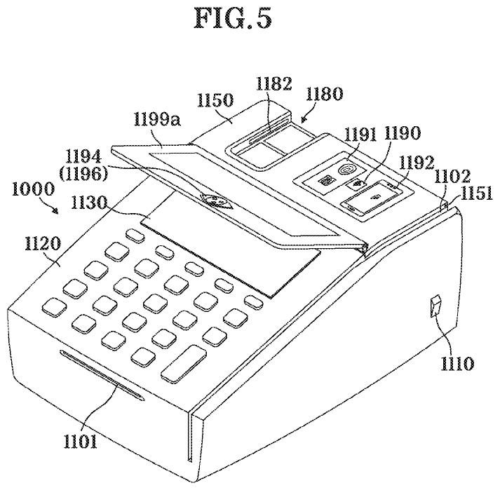

FIG. 5 is a perspective view schematically showing a configuration of a first embodiment of the integrated payment device using the POS terminal of embodiments of the present invention;

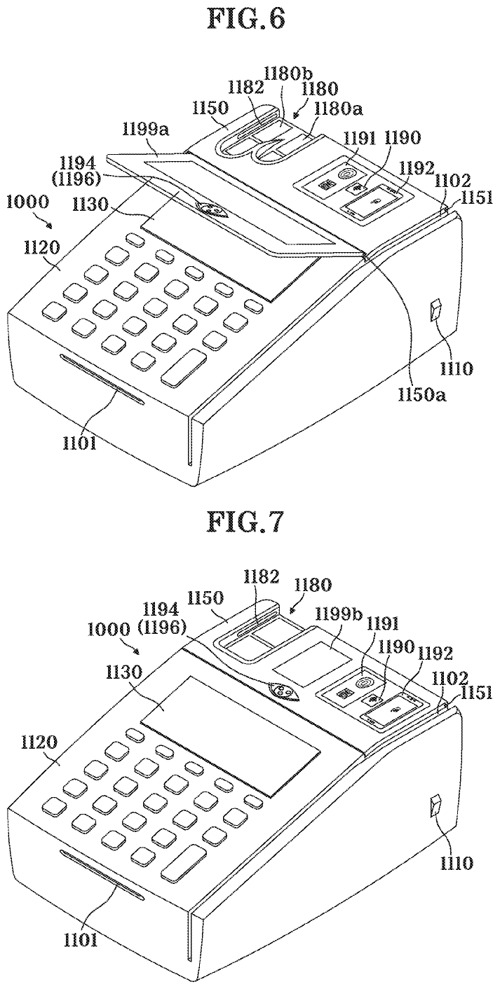

FIG. 6 is a perspective view schematically a showing configuration of a second embodiment of the integrated payment device using the POS terminal of embodiments of the present invention;

FIG. 7 is a perspective view schematically showing configuration a third embodiment of the integrated payment device using the POS terminal of an embodiment of the present invention;

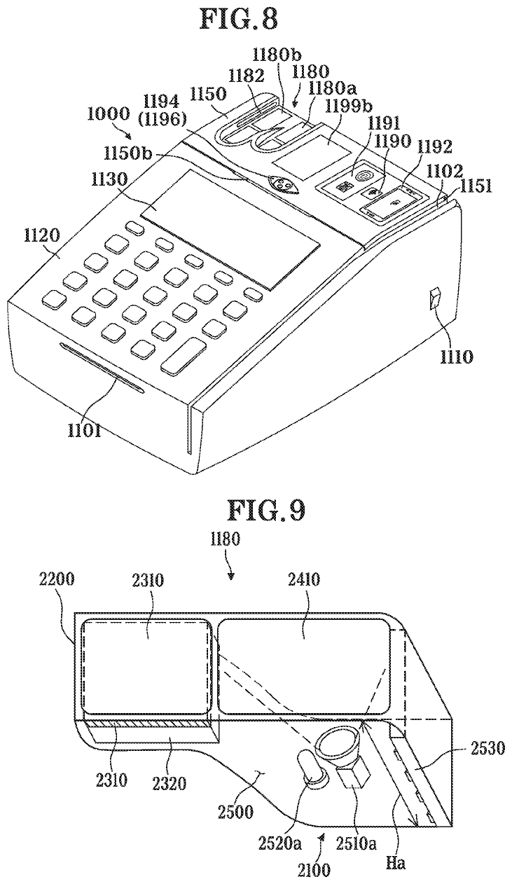

FIG. 8 is a perspective view schematically showing configuration a third embodiment of the integrated payment device using the POS terminal of an embodiment of the present invention;

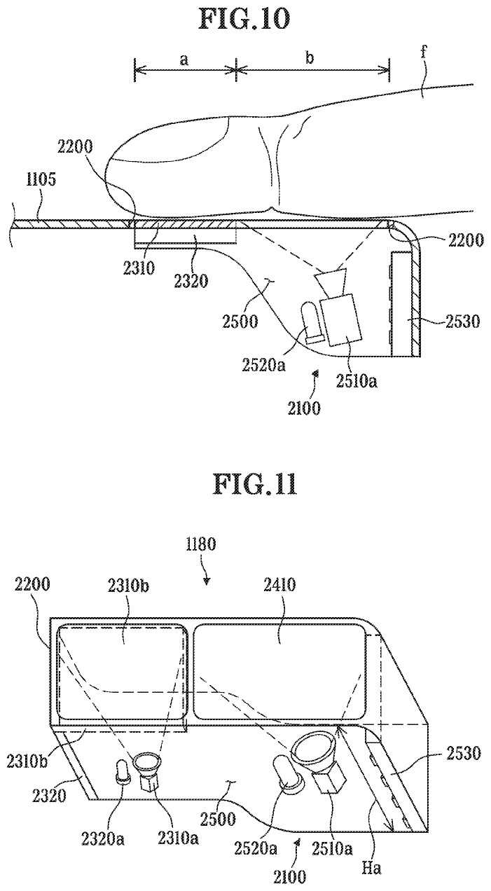

FIG. 9 is a perspective view schematically showing a contact-type fingerprint and finger vein authentication device of the integrated payment device using the POS terminal according to embodiments of the present invention;

FIG. 10 is a side view schematically showing the contact-type fingerprint and finger vein authentication device of the integrated payment device using the POS terminal according to embodiments of the present invention;

FIG. 11 is a perspective view schematically showing an optical-type fingerprint and finger vein authentication device of the integrated payment device using the POS terminal according to embodiments of the present invention;

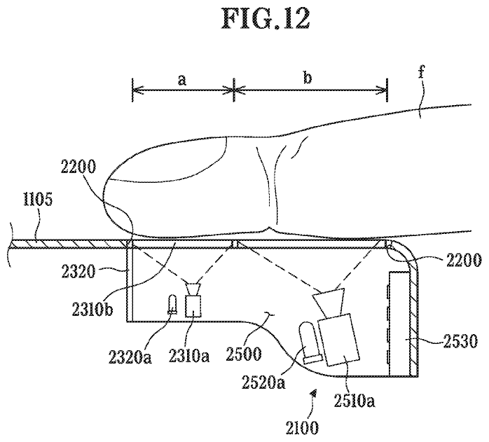

FIG. 12 is a side view schematically showing the optical-type fingerprint and finger vein authentication device of the integrated payment device using the POS terminal according to embodiments of the present invention;

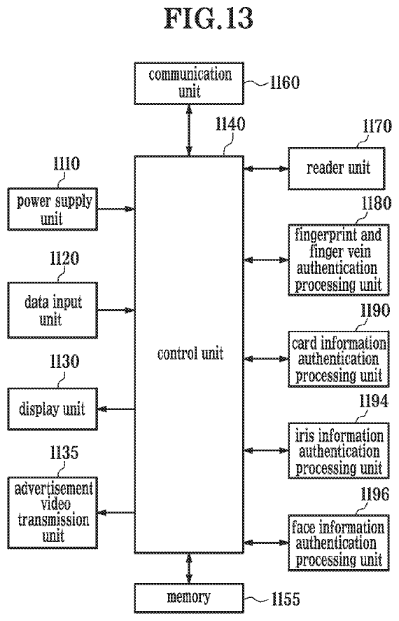

FIG. 13 is a block diagram schematically showing a configuration of the integrated payment device using the POS terminal according to embodiments of the present invention;

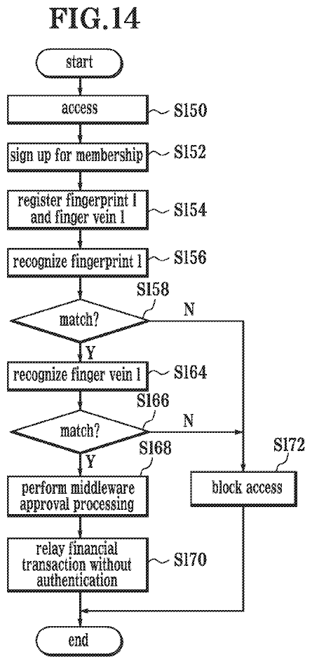

FIG. 14 is a flowchart in a case in which both of a first fingerprint and a first finger vein of embodiments of the present invention are recognized;

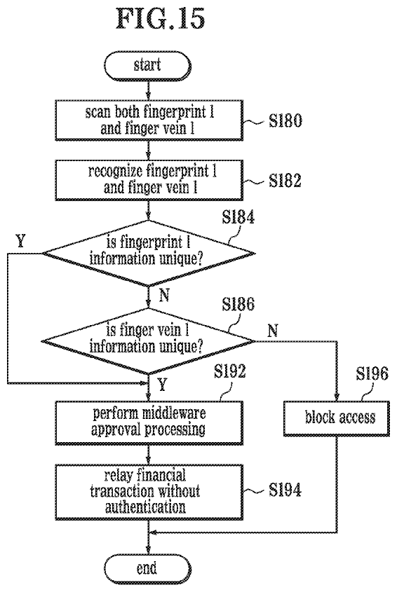

FIG. 15 is a flowchart in a case in which both of a first fingerprint and a first finger vein of embodiments of the present invention are recognized;

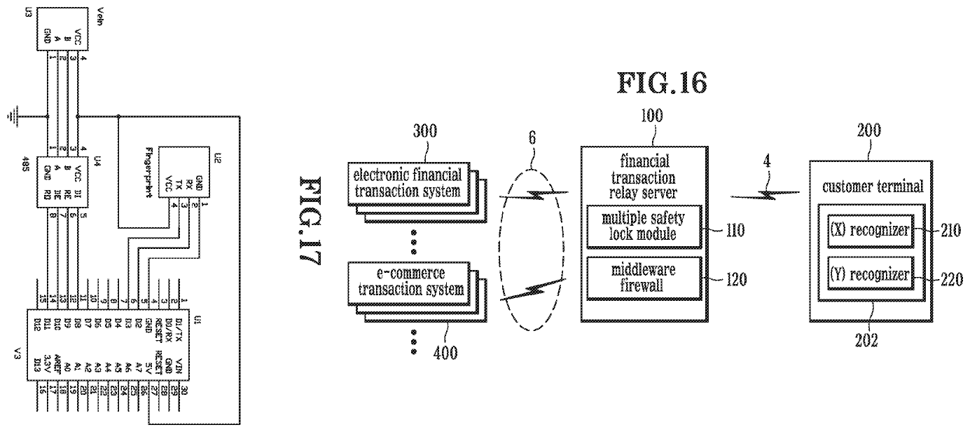

FIG. 16 is a block diagram showing a financial transaction system of embodiments of the present invention;

FIG. 17 is a diagram showing an integrated input/output module that interoperates an algorithm for a fingerprint and a finger vein;

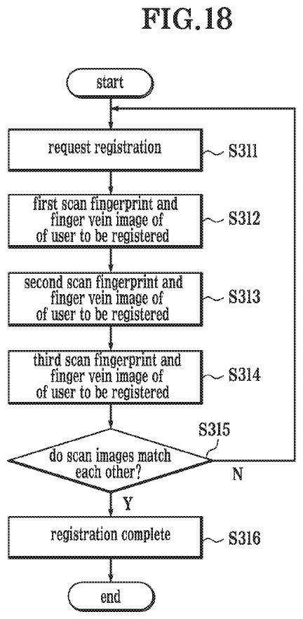

FIG. 18 is a flowchart illustrating that the registration of a fingerprint and a finger vein is requested;

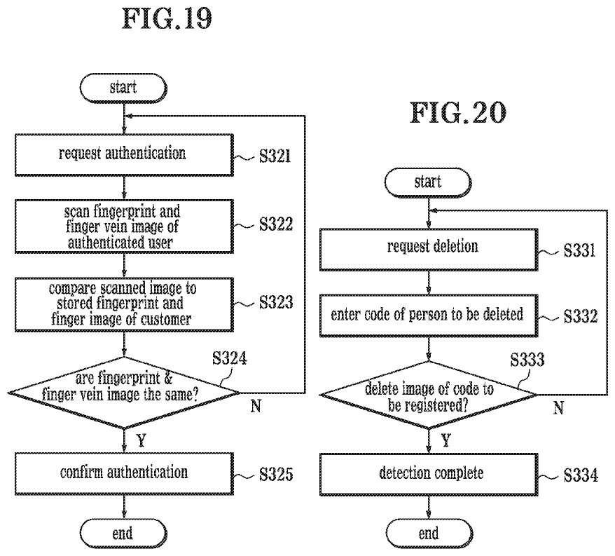

FIG. 19 is a flowchart illustrating that the authentication of a fingerprint and a finger vein is requested;

FIG. 20 is a flowchart illustrating that the deletion of a fingerprint and a finger vein is requested;

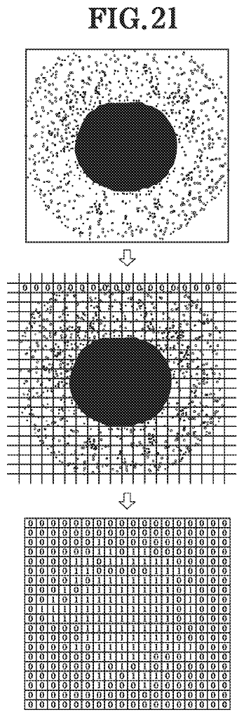

FIG. 21 is a diagram illustrating a method for normalization with binary data in an iris recognition method using an iris close-up camera;

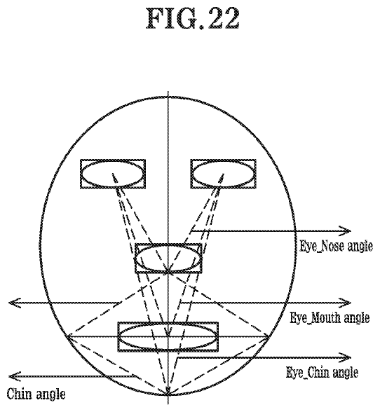

FIG. 22 is a diagram showing a schematic configuration of a face image entered according to a face recognition method;

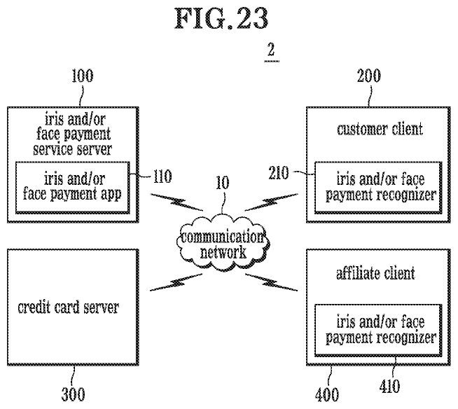

FIG. 23 is a block diagram showing a network configuration of an electronic payment system providing an iris and/or face payment service according to embodiments of the present invention.

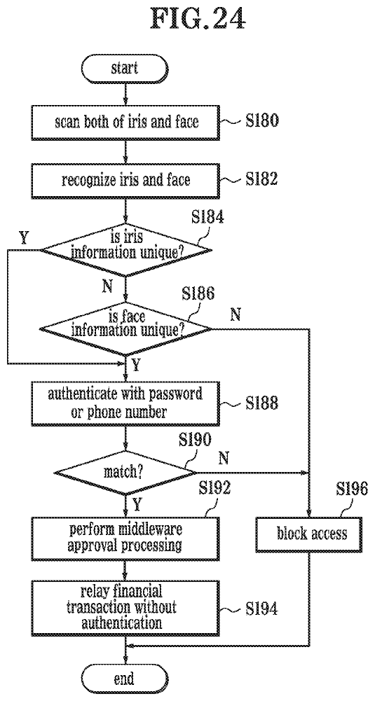

FIG. 24 is a flowchart illustrating examples of a processing procedure of a financial transaction relay system having a multiple safety lock function configured to process user authentication by scanning an iris and a face at the same time according to an embodiment of the present invention;

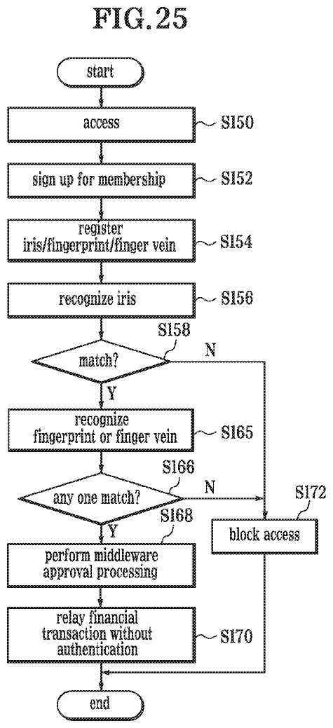

FIG. 25 is a flowchart illustrating examples of a processing procedure of a financial transaction relay system having a multiple safety lock function configured to process user authentication by scanning an iris and a face at the same time according to an embodiment of the present invention;

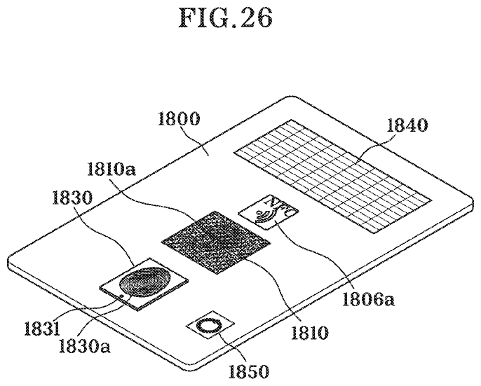

FIG. 26 shows an authentication card in which an identification picture is not displayed along with a near-field communication (NFC) function operating due to a solar cell according to an embodiment of the present invention;

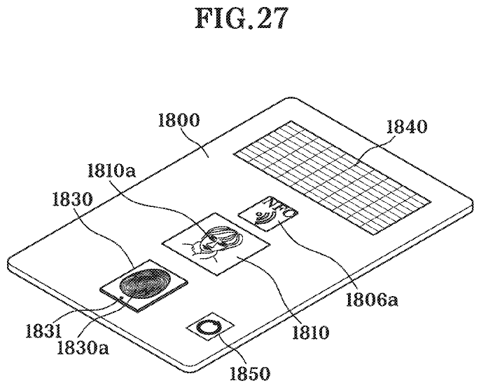

FIG. 27 shows an authentication card in which an identification picture is displayed along with an NFC function operating due to a solar cell according to an embodiment of the present invention;

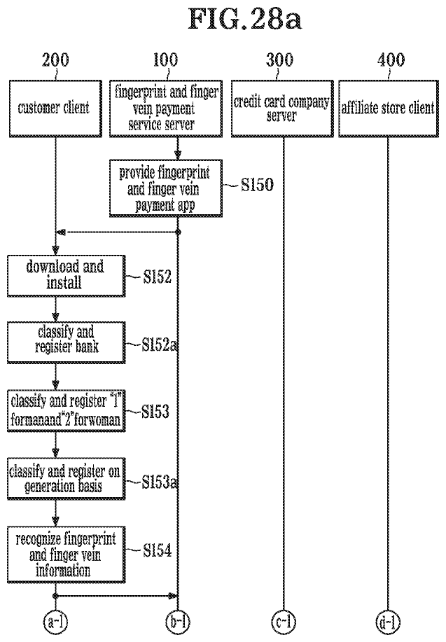

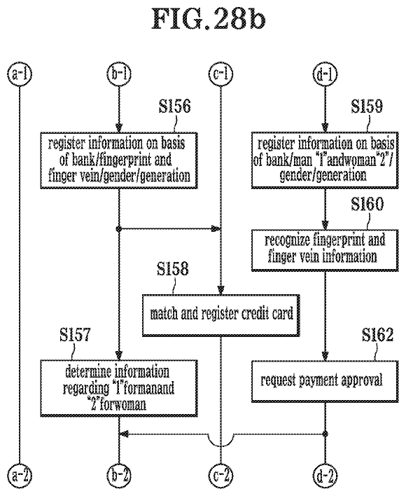

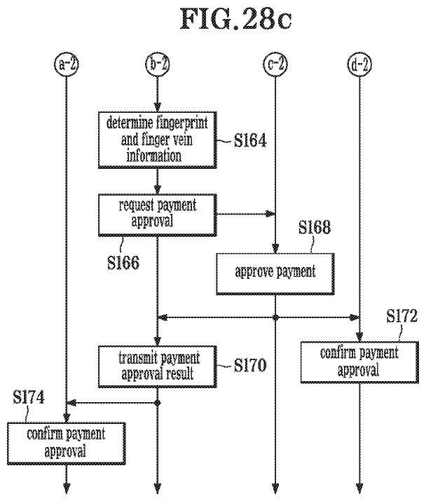

FIG. 28(a) is a flowchart illustrating a processing procedure of another electronic payment system according to embodiments of the present invention;

FIG. 28(b) is a flowchart illustrating a processing procedure of another electronic payment system according to embodiments of the present invention;

FIG. 28(c) is a flowchart illustrating a processing procedure of another electronic payment system according to embodiments of the present invention;

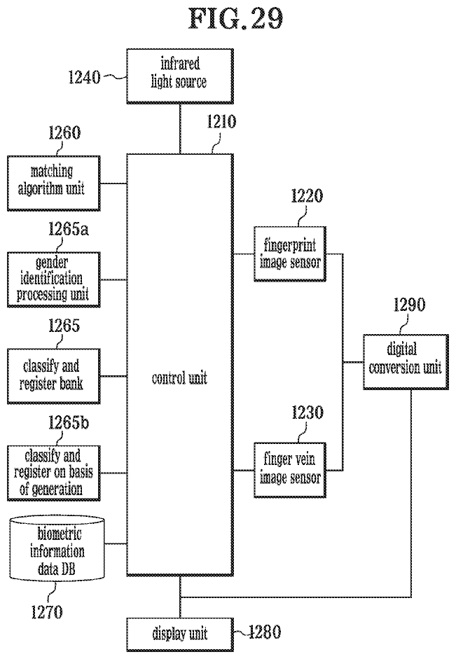

FIG. 29 is a diagram showing an internal electronic configuration of a fingerprint and/or finger vein capture authentication device 1200 according to a preferred embodiment of the present invention;

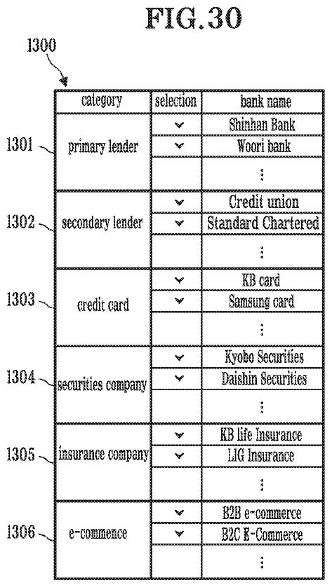

FIG. 30 is an organization diagram for bank classification according to embodiments of the present invention;

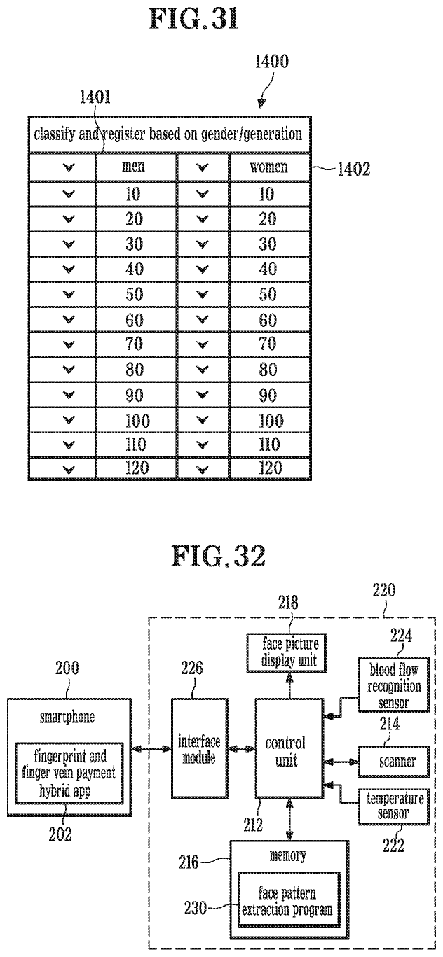

FIG. 31 is an organization diagram for classification based on gender and age by decade according to embodiments of the present invention;

FIG. 32 is a block diagram applied to a fingerprint and finger vein payment-specific hybrid web linked to a customer client and a smartphone of embodiments of the present invention;

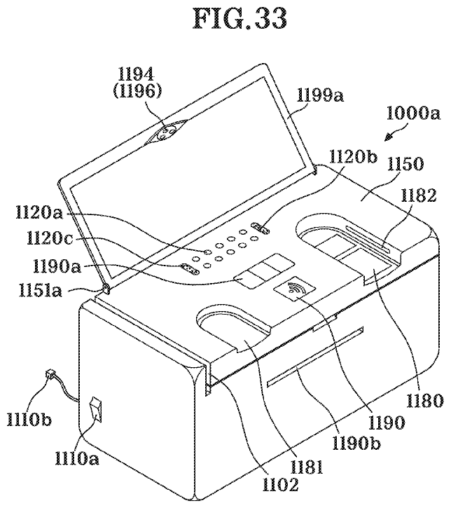

FIG. 33 is a schematic perspective view of an integrated biometric authentication terminal separated from the POS terminal of embodiments of the present invention;

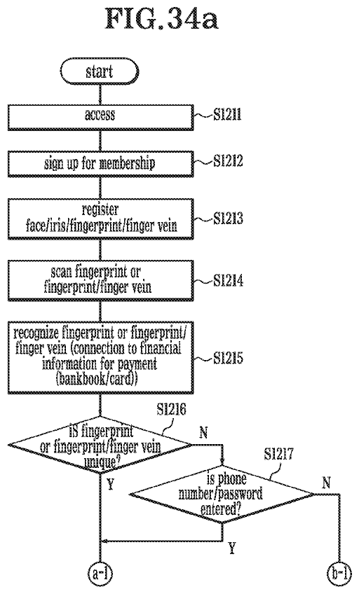

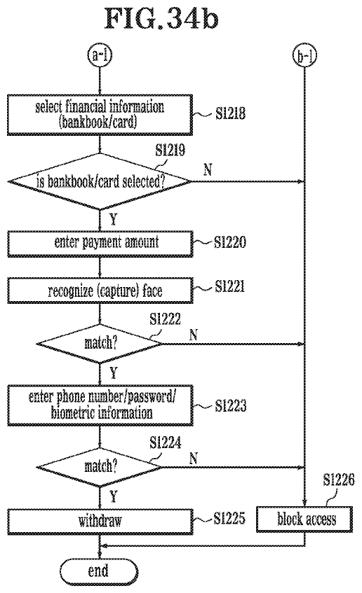

FIG. 34(a) is a diagram of an operating procedure of an integrated biometric authentication terminal of embodiments of the present invention;

FIG. 34(b) is a diagram of an operating procedure of an integrated biometric authentication terminal of embodiments of the present invention;

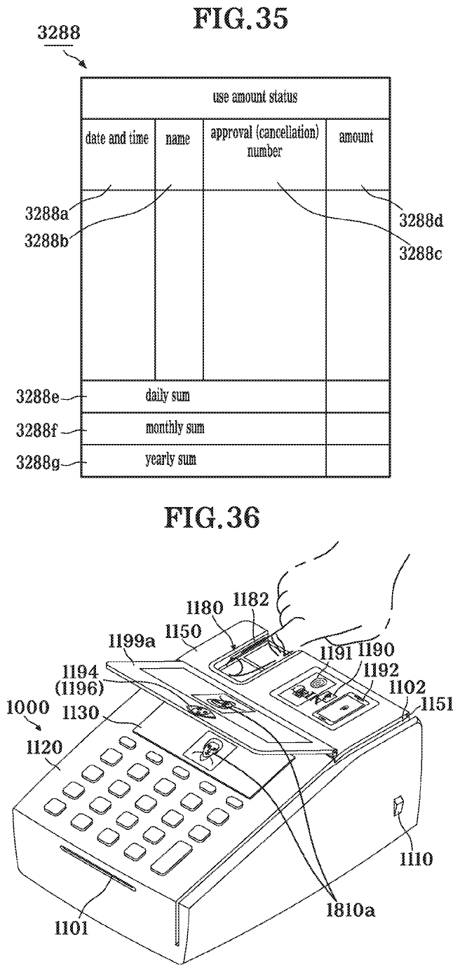

FIG. 35 is a usage amount status table checked in the integrated biometric authentication terminal of embodiments of the present invention;

FIG. 36 is a diagram showing a state in which a user's face photo is displayed on both of a clerk terminal and a customer terminal upon finger authentication in the final payment step or before financial information is selected in an integrated terminal of embodiments of the present invention;

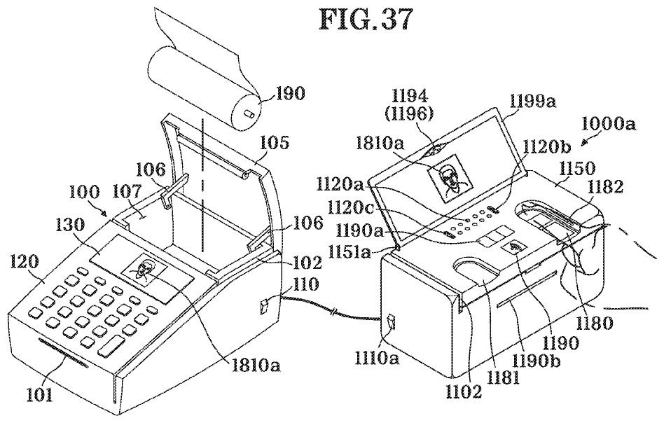

FIG. 37 is a diagram showing a coupling state with a conventional terminal in which a user's face photo is displayed upon finger authentication in the final payment step or before financial information is selected in an integrated biometric authentication terminal of embodiments of the present invention;

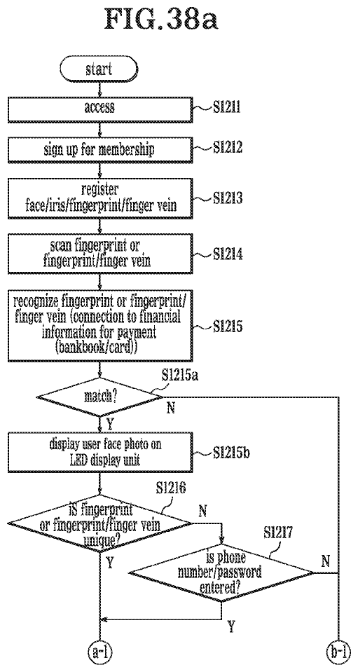

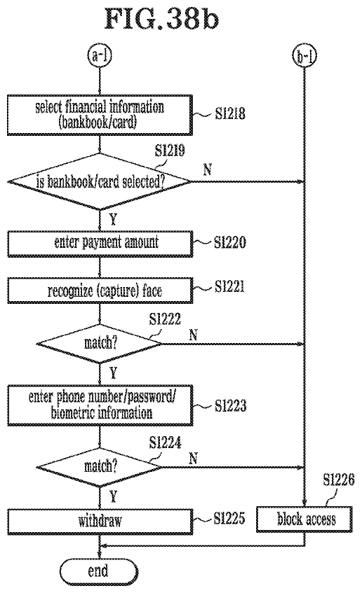

FIG. 38(a) is a diagram showing an operating procedure in which a user's face photo is displayed upon finger authentication before financial information is selected in an integrated biometric authentication terminal of embodiments of the present invention;

FIG. 38(b) is a diagram showing an operating procedure in which a user's face photo is displayed upon finger authentication before financial information is selected in an integrated biometric authentication terminal of embodiments of the present invention;

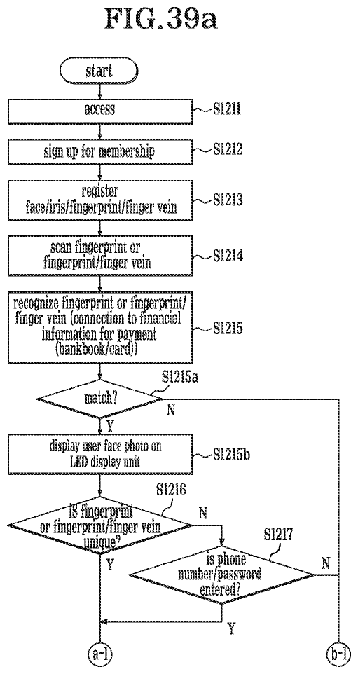

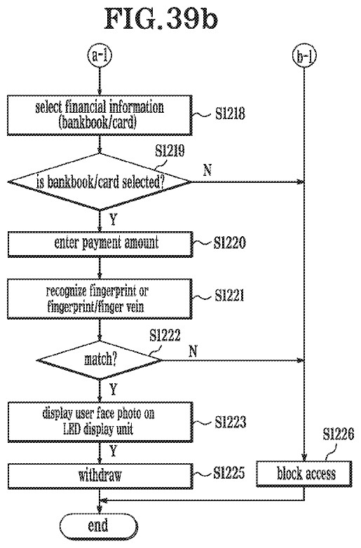

FIG. 39(a) is a diagram showing an operating procedure in which a user's face photo is displayed upon finger authentication in the final payment step or before financial information is selected in an integrated biometric authentication terminal of embodiments of the present invention;

FIG. 39(b) is a diagram showing an operating procedure in which a user's face photo is displayed upon finger authentication in the final payment step or before financial information is selected in an integrated biometric authentication terminal of embodiments of the present invention;

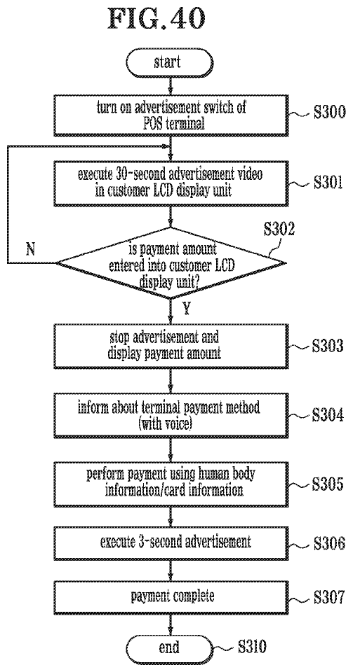

FIG. 40 is a diagram showing an advertisement execution procedure performed by a customer liquid crystal display (LCD) display unit applied to the integrated payment device using the POS terminal of embodiments of the present invention; and

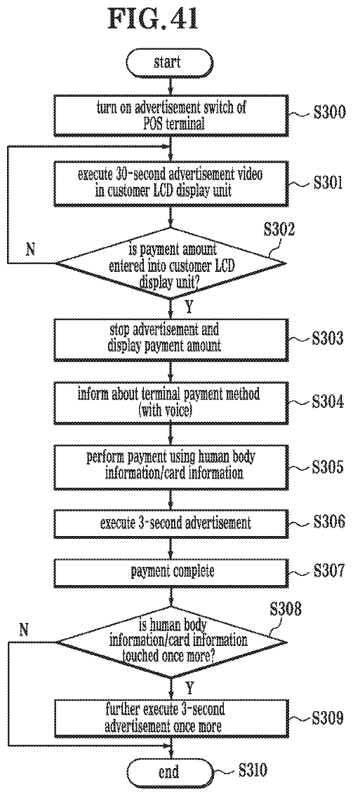

FIG. 41 is a diagram showing an additional advertisement execution procedure performed by the customer LCD display unit applied to the integrated payment device using the POS terminal of embodiments of the present invention.

### REFERENCE SYMBOLS

1000: POS terminal
1100: Power supply unit
1105: Electronic cover
1120: Data input unit
1130: Display unit
1135: Advertisement image transmission unit
1140: Control unit
1150: Memory unit
1160: Communication unit
1170: Reader unit
1180: Fingerprint and finger vein authentication processing unit
1190: Card information authentication processing unit
1194: Iris information authentication processing unit
1196: Face information authentication processing unit

### DETAILED DESCRIPTION

In the following description of embodiments of the present invention, detailed descriptions of related well-known functions will be omitted when it is determined that the functions are obvious to those skilled in the art and also may unnecessarily obscure the subject matter of embodiments of the present invention.

The embodiments are a non-authenticated access payment system on the basis of near-field communication (NFC) integrated financial payment without passing through a Value Added Network (VAN) provider. The usage range of an electronic card using biometric authentication security may cover (1) electronic card financial transaction, (2) electronic securities card, (3) electronic insurance card, (4) electronic resident card, (5) electronic immigration management card, (6) electronic passport card, (7) electronic driver license card, (8) electronic time and attendance card, and others.

FIGS. 5 and 6 are perspective views schematically showing configurations of first and second embodiments of the integrated payment device using a point-of-sale (POS) terminal of embodiments of the present invention, and FIGS. 7 and 8 are perspective views schematically showing configurations of third and fourth embodiments of the integrated payment device using the POS terminal of embodiments of the present invention.

The terminal according to the first embodiment of the present invention, that is, a POS terminal 1000 shown in FIG. 5, has a magnetic card check unit 1102 formed on one side and an integrated circuit (IC) card check unit 1101 formed in a lower portion. When a power supply unit 1110 is turned on, a payment amount is displayed by a data input unit 1120 on a clerk liquid crystal display (LCD) display unit 1130 so that a final payment button may be pushed.

Also, an electronic cover 1150 is formed on the front surface of the POS terminal 1000 as a payment system. A fingerprint and finger vein authentication processing unit 1180 for only one finger is formed on one side, and a card information authentication processing unit 1190 is formed on the other side. The card information authentication processing unit 1190 may have an authentication card tag unit 1191 and a smartphone tag unit 1192 formed therein. A single guide display unit may be devised when the authentication card tag unit 1191 and the smartphone tag unit 1192 have functions capable of being integrated with each other or the same function. However, now, the design is made for the purpose of conveying a meaning that an independent card can be used with two guide marks and for the purpose of conveying a meaning that a card registered in a smartphone can be used.

Also, a customer LCD display unit 1199a is formed in an upper portion of the electronic cover 1150 by a hinge (not shown) such that angle adjustment is possible according to a customer's location, and a customer's payment amount and a sign of appreciation are displayed on the customer LCD display unit 1199a. In addition, an advertisement function is additionally operated.

Also, an iris information authentication processing unit 1194 is formed on an upper end of the customer LCD display unit 1199a, and a face information authentication processing unit 1196 is designed and formed along with the iris information authentication processing unit 1194.

Reference number 1182 indicates an infrared transmission unit 1182 configured to additionally perform transmission in the fingerprint and finger vein authentication processing unit 1180.

When the customer LCD display unit 1199a is not normally used mechanically or when payment is possible only with the clerk LCD display unit 1130 as in the related art, the customer LCD display unit 1199a is folded using the hinge. The electronic cover 1150 may be opened with respect to the hinge in order to repair internal computer equipment.

The terminal according to the second embodiment of the present invention, that is, the POS terminal 1000 shown in FIG. 6 is different from that according to the first embodiment in that a fingerprint and finger vein authentication processing unit 1180 corresponding to two fingers, i.e., an index finger 1180a and a middle finger 1180b, is formed on one side and in that the customer LCD display unit 1199a may be inserted into and pulled from the main body by the LCD display housing unit 1150a of the main body in a sliding manner.

The terminal according to the third embodiment of the present invention, that is, a POS terminal 1000 shown in FIG. 10 has a relatively large size and also has a magnetic card check unit 1102 formed on one side and an IC card check unit 1101 formed in a lower portion. When the power supply unit 1110 is turned on, a payment amount is displayed on the clerk LCD display unit 1130 by the data input unit 1120 so that a final payment button may be pushed.

Also, an electronic cover 1150 is formed on the front surface of the POS terminal 1000 as a payment system. A fingerprint and finger vein authentication processing unit 1180 for only one finger is formed on one side, and a card information authentication processing unit 1190 is formed in a lower central portion. The card information authentication processing unit 1190 may have an authentication card tag unit 1191 and a smartphone tag unit 1192 formed therein. A single guide display unit may be devised when the authentication card tag unit 1191 and the smartphone tag unit 1192 have functions capable of being integrated with each other or the same function. However, now, the design is made for the purpose of conveying a meaning that an independent card can be used with two guide marks and for the purpose of conveying a meaning that a card registered in a smartphone can be used.

Also, a customer LCD display unit 1199b is formed on one side of the electronic cover 1150, and a customer's payment amount and a sign of appreciation may be displayed on the customer LCD display unit 1199b. Also, an advertisement may be provided according to the size of the customer LCD display unit 1199b. Also, an iris information authentication processing unit 1194 is formed on an upper end of the electronic cover 1150, and a face information authentication processing unit 1196 is designed and formed along with the iris information authentication processing unit 1194.

Reference number 1182 indicates an infrared transmission unit 1182 configured to additionally perform transmission in the fingerprint and finger vein authentication processing unit 1180.

Upon normal use in a mechanical manner, a customer may make a payment while facing a clerk. The electronic cover 1150 may be opened with respect to the hinge 1151 in order to repair internal computer equipment.

The terminal according to the fourth embodiment of the present invention, that is, the POS terminal 1000 shown in FIG. 8, is different from that according to the third embodiment in that a fingerprint and finger vein authentication processing unit 1180 corresponding to two fingers, i.e., an index finger 1180a and a middle finger 1180b, is formed on one side and in that a printing paper exit 1150b is formed between the electronic cover 1150 and the main body such that in a country having a system requiring conventional receipts such a type of main body can be produced.

The fingerprint and finger vein authentication processing unit 1180, the iris information authentication processing unit 1194, and the face information authentication processing unit 1196 will be described in detail below.

First, a contact-type fingerprint and finger vein authentication apparatus will be described.

FIG. 9 is a perspective view schematically showing a contact-type fingerprint and finger vein authentication device of the integrated payment device using the POS terminal according to embodiments of the present invention, FIG. 10 is a side view schematically showing the contact-type fingerprint and finger vein authentication device of the integrated payment device using the POS terminal according to embodiments of the present invention, FIG. 11 is a perspective view schematically showing an optical-type fingerprint and finger vein authentication device of the integrated payment device using the POS terminal according to embodiments of the present invention, and FIG. 12 is a side view schematically showing the optical-type fingerprint and finger vein authentication device of the integrated payment device using the POS terminal according to embodiments of the present invention.

As shown in the drawing, according to embodiments of the present invention, the fingerprint and finger vein authentication processing unit 1180 formed in the POS terminal 1000 has a contact-type fingerprint scan module 2310 formed in an upper portion and a finger vein authentication device unit 2100 having a finger capture groove 2410 formed on a lower portion, the finger vein authentication device unit 2100 having a finger capture groove 2410 to perform fingerprint and finger vein authentication.

The fingerprint scan model 2310 uses a contact-type recognition module and has a recognition circuit electronic-part 2320 formed on the bottom surface to control the contact-type recognition module.

The authentication device unit 2100 for acquiring the finger vein information is formed to authenticate a finger vein at a lower corner of the side surface of the main body of the terminal. A substantial authentication device unit space 2500 capable of housing the contact-type fingerprint scan module 2310 and the finger vein authentication device unit 2100 is formed inside the terminal in a shape having a narrow upper portion and a wide lower portion, and a side surface groove boundary 2200 is formed outside the terminal. The contact-type fingerprint scan module 2310 is formed in an upper portion, and the finger capture groove 2410 is formed in a lower portion such that a finger f can be placed thereon in a non-contact manner and also be recognized at the same time.

A very thin finger support glass plate may be formed on the finger capture groove 2410 to prevent ingress of external dirt and the like.

In this case, an image sensor may be operated by utilizing the finger support glass plate, that is, by attaching an infrared filtering film for blocking visible light to the finger support glass plate.

In addition, the finger support glass plate may be formed in a front side portion adjacent to an image sensor 2510a and an infrared transmission unit 2520a along with the infrared filtering film.

Also, an empty finger capture groove 2410 is formed on a lower side such that the finger f is comfortably placed thereon.

Also, in the authentication device unit space 2500 on the bottom surface of the empty finger capture groove 2410, the image sensor 2510a and the infrared transmission unit 2520a are formed in parallel with each other, and a recognition circuit electronic unit 2530 for controlling the image sensor 2510a and the infrared transmission unit 2520a is formed. When a finger vein pattern is recognized, the image sensor 2510a and the infrared transmission unit 2520a are operated to transmit various control signals.

As long as the empty finger capture groove 2410 is designed to prevent damage to the image sensor 2510a and the infrared emitting unit 2520a, the empty finger capture groove 2410 may be formed to communicate with the authentication device unit space 2500 in a non-contact manner according to the surrounding conditions.

Also, the image sensor 2510a has a different finger vein recognition range depending on the size. Accordingly, by increasing a distance Ha with the finger f, the image sensor 2510a may recognize a finger vein in a wide range. When the distance is small, the image sensor 2510a may recognize a finger vein in a narrow range. Therefore, the image sensor 2510a should be devised and designed in consideration of a relationship with the size of the electronic unit of the terminal.

Accordingly, the present inventor freely has devised a design of a terminal itself by decreasing a corresponding depth other than the above embodiment, that is, the distance Ha with the finger f

Reference number 1105 indicates a support plate of the fingerprint and finger vein authentication processing unit.

The following description relates to another embodiment of a fingerprint authentication processing unit in the fingerprint and the finger vein authentication processing unit.

As shown in FIGS. 11 and 12, a general structure is almost the same as that described above. In the above embodiment, the fingerprint scan module 2310 uses a contact-type recognition module as the fingerprint authentication processing unit, and the recognition circuit electronic unit 2320 for controlling the contact-type recognition module is formed on the bottom surface. However, as another embodiment, the fingerprint scan module 2310 uses an optical-type recognition module, and the optical-type recognition module is composed of an image sensor 2310a and an infrared transmission unit 2320a such that a fingerprint is irradiated with infrared rays and imaged, and a recognition circuit electronic unit 2320 for controlling the image sensor 2310a and the infrared transmission unit 2320a is formed on the bottom surface.

The following description relates to the configuration of the integrated payment device using the POS terminal of embodiments of the present invention.

FIG. 13 is a block diagram schematically showing the configuration of the integrated payment device using the POS terminal according to embodiments of the present invention.

As shown, the POS terminal 1000 includes a power supply unit 1110, a data input unit 1120, a display unit 1130, an advertisement image transmission unit 1135, a control unit 1140, a memory 1155, a communication unit 1160, a reader unit 1170, a fingerprint and finger vein authentication processing unit 1180, a card information authentication processing unit 1190, an iris information authentication processing unit 1194, and a face information authentication processing unit 1196.

The power supply unit 1110 supplies operating power to operate the device.

The data input unit 1120 consists of a keyboard, a touch panel, and the like provided outside the device, and outputs, to the control unit 1140, real-time information based on a workplace situation entered by a workplace manager.

The display unit 1130 displays, on the screen, the real-time information entered through the data input unit 1120. Also, the display unit 1130 is an LCD display unit configured to display operating information (e.g., sales information, etc.) related to sales at a typical workplace and configured to perform an advertisement action such as showing a video.

The advertisement image transmission unit 1135 is an advertisement image transmission unit that enables an advertisement image to be produced as a short video such that the image is displayed on customer LCD display units 1190a and 11900b of the POS terminal 1000 in order to perform the advertisement at a normal time or that enables a short advertisement video to be operated to perform an advertisement upon payment with a finger, that is, a fingerprint or a finger vein.

The control unit 1140 performs control such that real-time information reflecting a business state of the workplace corresponding to an input operation of the workplace manager received through the data input unit 1120 is stored in the memory 1150 and performs control such that the real-time information is transmitted to an information management server computer through the communication unit 1160.

Also, when a cost is paid based on the real-time information, the control unit 1140 activates information about a cost to be paid by a user who uses a workplace according to the operation of the manager, performs control such that real-time benefit (discount) information displayed on the user terminal 1000 is read through the reader unit 1170, performs control such that the benefit information read by the reader unit 1170 is transmitted to an information management server computer through the communication unit 1160 along with the payment cost information, and performs control such that the cost for the use of the workplace is paid on the basis of calculation information reflecting the benefit (discount) when the calculation information is transmitted from the information management server computer.

Also, when a cost is paid based on the real-time information, the control unit 1140 activates information about a cost to be paid by a user who uses a workplace according to the operation of the manager, performs control such that the information about the cost to be paid by the user is transmitted to the information management server computer through the communication unit 1160, and performs control such that the payment of the cost for the use of the workplace is processed on basis of calculation information reflecting a benefit (discount) provided to a user who is paying the cost when the calculation information is transmitted from the information management server computer through the communication unit 1160. In this case, the calculation information reflecting the benefit (discount) received from the information management server computer may be determined based on the payment cost information and the benefit (discount) information by the information management server computer that has recognized the operation of a user who clicks benefit (discount) information of real-time information displayed on the user terminal (smartphone, etc.).

The memory 1155 stores a control program for driving the POS terminal 1000 and also stores real-time information entered by the workplace manager, cost payment information according to the use of the real-time information, settlement processing information of an accrued profit, and the like.

The communication unit 1160 transmits real-time information directly entered by the workplace manager to the information management server computer over a network communication network under the control of the control unit 1140.

The reader unit 1170 includes a scanner, a card reader, and the like, and recognizes the real-time information displayed on the user terminal (smartphone, etc.) when a user who has visited the workplace pays a cost for the use of the workplace on the basis of the real-time information. Also, in the case of a general card payment, a cost is paid by recognizing card information and by transmitting and receiving payment data such as card information and amount information to and from a payment server computer through the communication unit 1160.

The fingerprint and finger vein authentication processing unit 1180 converts fingerprint and finger vein information entered by a user who performs a general card payment into digital data and outputs the digital data to the control unit 1140.

The card information authentication processing unit 1190 outputs the card information entered by the user who performs the general card payment to the control unit 1140.

The iris information authentication processing unit 1194 converts iris information entered by the user who performs the general card payment into digital data and outputs the digital data to the control unit 1140.

The face information authentication processing unit 1196 converts iris information entered by the user who performs the general card payment into digital data and outputs the digital data to the control unit 1140.

The signature or receipt is replaced by the fingerprint, the finger vein, the iris, and face authentication. Data regarding the used fingerprint, finger vein, iris, and face authentication of the user is stored when necessary, and thus it is possible to easily identify a theft or the like by performing computerized processing on the data.

The following description relates to a method of authenticating a fingerprint and a finger vein.

FIGS. 14 and 15 are flowcharts in a case in which both of a first fingerprint and a first finger vein of embodiments of the present invention are recognized, and FIG. 16 is a block diagram showing a financial transaction system of embodiments of the present invention.

FIG. 14 is a flowchart illustrating a different example of a processing procedure of a financial transaction relay system having a multiple safety lock function using first fingerprint authentication according to an embodiment of the present invention.

Referring to FIG. 14, in a financial transaction relay system 2 of embodiments of the present invention, a customer terminal 200 accesses a financial transaction relay server 100 over a communication network 4 in S150 and signs up for membership in S152. In this case, a customer's personal information such as a name, an ID, a password, a phone number, and an email address is entered through the customer terminal 200.

(Here, a first fingerprint and a first finger vein have (ordinal) numbers in consideration that two fingers may be used).

In S154, when the customer terminal 200 acquires first finger vein information and first fingerprint information through a first finger vein recognizer 210 and a first fingerprint recognizer 220 and transmits the first finger vein information and the first fingerprint information to the financial transaction relay server 100 over the communication network 4, the financial transaction relay server 100 resisters the first finger vein information and the first fingerprint information to correspond to the customer terminal 200. In this case, the financial transaction relay server 100 stores the first finger vein information and the first fingerprint information in a database.

In order to perform an electronic financial transaction and an e-commerce transaction, primarily, the financial transaction relay server 100 recognizes the first fingerprint in S156 and determines whether the first fingerprint matches the first fingerprint information stored in the database to authenticate the user of the customer terminal 200 in S158.

When the determination result is that the first fingerprint matches the first fingerprint information, the financial transaction relay server 100 secondarily recognizes the first finger vein in S164 and determines whether the first finger vein matches the first finger vein information stored in the database in S166.

When the determination result is that the first finger vein matches the first finger vein information, the procedure proceeds to S168. Tertiarily, the financial transaction relay server 100 releases its firewall to allow a multiple safety lock module 110 to open the database of the financial transaction relay server 100 through a middleware approval processing unit 120. Subsequently, in S170, the financial transaction relay server 100 accesses an electronic financial transaction system 300 or an e-commerce transaction system 400 without authentication to relay the financial transaction.

However, when the first finger vein does not match the first finger vein information in S158 or when the first fingerprint does not match the first fingerprint information in S166, this procedure proceeds to S172, and the financial transaction relay server 100 blocks the access of the financial transaction relay server 100 in order not to perform the electronic financial transaction and the e-commerce transaction.

Since the recognition of the first fingerprint is possible only when a user is alive, the recognition is allowed for only the user, and thus security is not affected even though an additional password process or the like is omitted.

Also, FIG. 15 is a flowchart illustrating a different example of a processing procedure of a financial transaction relay system having a multiple safety lock function configured to process user authentication by scanning both of the first fingerprint and the first finger vein according to another embodiment of the present invention. This embodiment is performed when user identification is difficult because the first fingerprint and the first finger vein are the same as or similar to their corresponding information. Primary user authentication is processed using the first fingerprint information. When the user identification is difficult in the primary user authentication, secondary user authentication is processed using the first finger vein information.

That is, referring to FIG. 15, in S180, the financial transaction relay system 2 of embodiments of the present invention scans both of the first finger vein and the first fingerprint by means of the first finger vein recognizer 210 and the first fingerprint recognizer 220 of the customer terminal 200 and provides first finger vein information and first fingerprint information to the financial transaction relay server 100.

The financial transaction relay server 100 recognizes the first fingerprint information and the first finger vein information in S182 and compares the first fingerprint information to the first fingerprint information stored in the database to determine whether the first fingerprint information is unique in S184.

When the determination result is that the first fingerprint information is unique, the procedure proceeds to S188. When the first fingerprint information is not unique, that is, when the first fingerprint information is the same as or similar to the stored first fingerprint information and thus user identification is difficult, the financial transaction relay server 100 compares the first finger vein information to the first finger vein information stored in the database to determine whether the first finger vein information is unique in S186.

When the determination result is that the first finger vein information is unique, the procedure proceeds to S188, and user authentication for releasing and blocking a firewall is processed.

The financial transaction relay server 100 releases the firewall to allow the multiple safety lock module 110 to open the database of the financial transaction relay server 100 through the middleware approval processing unit 120 in S192. Subsequently, in S194, the financial transaction relay server 100 accesses the electronic financial transaction system 300 or the e-commerce transaction system 400 without authentication to relay the financial transaction.

However, when the customer terminal 200 cannot perform user authentication using the first fingerprint information and the first finger vein information in S186 and S190, this procedure proceeds to S196, and the access of the financial transaction relay server 100 is blocked in order not to process the electronic financial transaction and the e-commerce transaction.

FIG. 16 is a flowchart illustrating a different example of a processing procedure of a financial transaction relay system having a multiple safety lock function using fingerprint and finger vein authentication according to an embodiment of the present invention.

Referring to FIG. 16, in the financial transaction relay system of embodiments of the present invention, the customer terminal 200 accesses the financial transaction relay server 100 over the communication network 4 in S150 and signs up for membership in S152. In this case, a customer's personal information such as a name, an ID, a password, a phone number, and an email address is entered through the customer terminal 200.

In S154, when the customer terminal 200 acquires finger vein information and fingerprint information through a finger vein recognizer 210 and a fingerprint recognizer 220 and transmits the finger vein information and the fingerprint information to the financial transaction relay server 100 over the communication network 4, the financial transaction relay server 100 resisters the finger vein information and the fingerprint information to correspond to the customer terminal 200.

In this case, the financial transaction relay server 100 stores the finger vein information and the fingerprint information in a database.

In order to perform an electronic financial transaction and an e-commerce transaction, the financial transaction relay server 100 primarily recognizes the fingerprint in S156 and determines whether the fingerprint matches the fingerprint information stored in the database to authenticate the user of the customer terminal 200 in S158.

When the determination result is that the fingerprint matches the fingerprint information, the financial transaction relay server 100 secondarily recognizes the finger vein in S164 and determines whether the finger vein matches the finger vein information stored in the database in S166.

When the determination result is that the finger vein matches the finger vein information, this procedure proceeds to S168. Tertiarily, the financial transaction relay server 100 releases its firewall to allow the multiple safety lock module 110 to open the database of the financial transaction relay server 100 through the middleware approval processing unit 120. Subsequently, in S170, the financial transaction relay server 100 accesses the electronic financial transaction system 300 or the e-commerce transaction system 400 without authentication to relay the financial transaction.

However, when the finger vein does not match the finger vein information in S158 or when the fingerprint does not match the fingerprint information in S166, the procedure proceeds to S172, and the financial transaction relay server 100 blocks the access of the financial transaction relay server 100 in order not to perform the electronic financial transaction and the e-commerce transaction.

Since the recognition of the finger vein is possible only when a user is alive, the recognition is allowed for only the user, and thus security is not affected even though an additional password process or the like is omitted.

An integrated module for interoperating an algorithm for a fingerprint and a finger vein for implementing the above procedure may be described as follows.

FIG. 17 is a diagram showing an integrated input/output module that interoperates an algorithm for a fingerprint and a finger vein, FIG. 18 is a flowchart illustrating that the registration of a fingerprint and a finger vein is requested, FIG. 19 is a flowchart illustrating that the authentication of a fingerprint and a finger vein is requested, and FIG. 20 is a flowchart illustrating that the deletion of a fingerprint and a finger vein is requested.

As shown in FIG. 17, an integrated input/output module U1 for interoperating the algorithm for the fingerprint and the finger vein is composed of a fingerprint scan module U2, a finger vein module U3, and a conversion module U4.

First, the fingerprint scan module U2 will be described.

In the fingerprint scan module U2, GND line #1 indicates a (−) voltage reference and functions as 0V ground, RX line #2 indicates a serial data reception port and functions to control a fingerprint module, TX line #3 indicates a serial data transmission port and functions to read a fingerprint module state, VCC line #4 indicates a (+) voltage reference of a power supply circuit and functions as +5V voltage input. Through the above configuration, the fingerprint scan module U2 scans a fingerprint by means of an image sensor, compares an image obtained through the scanning to prestored images, and then outputs authentication code registered for a person corresponding to the finger image in serial communication when the corresponding person is present (here, 232-communication is applied to this embodiment).

Here, 232-communication refers to a serial communication specification.

The following description relates to the finger vein module U3.

In the finger vein module U3, GND line #1 indicates a (−) voltage reference and functions as 0V ground, A line #2 indicates a serial communication specification RS485-communication port A and functions to receive and transmit data, B line #3 indicates a serial communication specification RS485-communication port B and functions to receive and transmit data, and VCC line #4 indicates a (+) voltage reference of a power supply circuit and functions as +5V voltage input. Through the above configuration, the finger vein module U3 scans a finger vein by means of a camera image sensor after penetrating a finger with an infrared LED, compares an image obtained through the scanning to prestored finger vein images, and then outputs authentication code registered for a person corresponding to the finger vein image in serial communication when the corresponding person is present (here, 485-communication is applied to this embodiment).

Here, 485-communication refers to a serial communication specification.

The following description relates to the 485-232-communication conversion module U4. On the left side of the conversion module U4, GND line #1 indicates a (−) voltage reference and functions as 0V ground, A line #2 indicates a serial communication specification RS485-communication port A and functions to receive and transmit data, B line #3 indicates a serial communication specification RS485-communication port B and functions to receive and transmit data, and VCC line #4 indicates a (+) voltage reference and functions as +5V voltage input. Through the above configuration, the conversion module U4 receives the 485-communication output from the finger vein module, converts the 485-communication into the 232-communication, and outputs the 232-communication.

Also, on the right side of the conversion module U4, DI line #5 indicates a serial 232-communication reception port and functions to receive data, RE line #6 indicates a 485-communication control port and functions to control the transmission and reception state of a 485-communication module, DE line #7 indicates a 485-communication control port and functions to control the transmission and reception state of a 485-communication module, and RO line #8 indicates a serial 232-communication transmission port and functions to transmit instructions. The conversion module U4 interoperates with the integrated module U1.

The following description relates to the integrated module U1 for the fingerprint and the finger vein input and the Universal Serial Bus (USB) output.

In the integrated module U1, D1/TX line #1 indicates a serial 232-communication transmission port and functions to transmit data to a computer, D0/RX line #2 indicates a serial 232-communication reception port and functions to receive data from a computer, GND line #4 indicates a (−) voltage reference and functions as 0V ground, D2 line #5 indicates a serial 232-communication transmission line for the fingerprint scan module U2 and functions to transmit an instruction to a fingerprint module, D3 line #6 indicates a serial 232-communication reception line for the fingerprint scan module U2 and functions to receive a state value of a fingerprint module, D8 line #11 indicates a serial 232-communication transmission port for the 485-232-communication conversion module U4 and functions to control the finger vein module U3, D9 line #12 indicates a 485-communication control port of the 485-232-communication conversion module U4 and functions to control the transmission and reception state of a 485-communication module, D10 line #13 indicates a 485-communication control port of the 485-232-communication conversion module U4 and functions to control the transmission and reception state of a 485-communication module, D11 line #14 indicates a serial 232-communication reception port of the 485-232-communication conversion module U4 and functions to read the state of the finger vein module U3, 5V line #27 is a (+) voltage 5V output PIN and functions to supply a 5V voltage to the fingerprint scan module U2, the finger vein module U3, and the 485-communication conversion module U4, GND line #29 indicates a (−) voltage reference and functions as 0V ground, and VIN line #30 indicates a (+) voltage reference and functions as +5V voltage input. Through the above configuration, the conversion module U4 converts fingerprint authentication code (a unique number of a customer having a registered fingerprint) output from the fingerprint scan module U2 and finger vein authentication code (a unique number of a customer having a registered finger vein) output from the finger vein module U3 into 232-communication, and the integrated module U1 receives the converted authentication codes and outputs the corresponding authentication codes through USB when the fingerprint authentication code and the finger vein authentication code match each other.

The fingerprint and finger vein algorithm of embodiments of the present invention may be displayed as follows:

```
int getfingerauthorization(int fingerprintcode,int fingerveincode)
{
  if( fingerprintcode>0 && fingerveincode>0 &&
  fingerprintcode==fingerveincode) )
  {
    return fingerprintcode;
  }
  return 0;
}.
```

The algorithm is an algorithm for receiving the fingerprint authentication code and the finger vein authentication code from the integrated module U1 and allowing the authentication codes only when the fingerprint and the finger vein are from the same person.

More details are as follows.

The fingerprint scan module U2 searches for a fingerprint. When there is a person having the corresponding fingerprint, the fingerprint scan module U2 outputs a code number of the corresponding person.

The finger vein module U3 searches for a finger vein. When there is a person having the finger vein, the finger vein module U3 outputs a code number of the corresponding person.

The fingerprint code of the fingerprint scan module U2 and the finger vein code of the finger vein module U3 are received through fingerprintcode and fingerveincode, which are factors of a function name getfingerauthorization of the above algorithm. Only when the two factor values are valid and also when the two unique customer numbers match each other, does the integrated fingerprint and finger vein module output the code of the corresponding person.

On the other hand, when the fingerprint code and the finger vein code are not valid or do not match each other, “0” is output as an error code.

The following description relates to a procedure for registration or authentication and deletion of a bank having a separate recognizer for a fingerprint and a finger vein.

First, as shown in FIGS. 18 to 20, a registration request is made by the fingerprint and finger vein recognizer as a step of registering a fingerprint and a finger vein (S311).

When the registration request is made by the fingerprint and finger vein recognizer, the fingerprint and finger vein recognizer performs a primary scan on a fingerprint and a finger vein of a person's finger to be registered (S312).

Subsequently, after the primary registration, the fingerprint and finger vein recognizer performs a secondary scan on the fingerprint and the finger vein of the person's finger to be registered (S313).

Subsequently, after the primary registration, the fingerprint and finger vein recognizer performs a tertiary scan on the fingerprint and the finger vein of the person's finger to be registered (S314).

In order to measure the accuracy of the registration performed three times by the fingerprint and finger vein recognizer, whether the three scan images match each other is determined (S315).

The registration is restarted when the three scan images obtained through the registration performed by the fingerprint and finger vein recognizer three times do not match each other, and the registration is complete when all of the three scan images match each other (S316).

By performing the process three times, accurate images of a fingerprint and a finger vein are registered.

Subsequently, an authentication request is made by the fingerprint and finger vein recognizer as a step of authenticating registration of the fingerprint and the finger vein (S321).

The fingerprint and finger vein recognizer scans images of the fingerprint and the finger vein of a user (S322).

The fingerprint and finger vein recognizer compares the scanned images to the fingerprint and the finer vein of the registered person's finger (S323).

The fingerprint and finger vein recognizer determines whether the scanned images match each other (S324).

The authentication is restarted when the scan images obtained by the fingerprint and finger vein recognizer do not match each other and is complete when the scan images match each other (S325).

Subsequently, a deletion request is made by the fingerprint and finger vein recognizer as a step of deleting the registration of the fingerprint and the finger vein (S331).

A user's code to be deleted is entered into the fingerprint and finger vein recognizer

(S332).

The fingerprint and finger vein recognizer determines whether to delete an image of a code to be registered (S333).

The authentication is restarted when the fingerprint and finger vein recognizer will not delete the scan image, and is complete when the fingerprint and finger vein recognizer will delete the scan image (S334).

With the registration or authentication and deletion method in a recognizer or bank capable of storing fingerprints and finger veins, it is possible to further improve the recognition of a fingerprint and a finger vein, and it is also possible to simplify the operation.

An iris and face authentication technique applied to the terminal will be described below. FIG. 21 is a diagram illustrating a method for normalization with binary data in an iris recognition method using an iris close-up camera, FIG. 22 is a diagram showing a schematic configuration of a face image entered according to a face recognition method, FIG. 23 is a block diagram showing a network configuration of an electronic payment system providing an iris and/or face payment service according to embodiments of the present invention, and FIGS. 24 and 25 are flowcharts illustrating examples of a processing procedure of a financial transaction relay system having a multiple safety lock function configured to process user authentication by scanning an iris and a face at the same time according to an embodiment of the present invention.

As shown in FIG. 21, in the case of iris authentication, when an image of an eye of a living person is captured, there is a change in a size of a pupil. Among iris images changing along with the change, a plurality of iris images are acquired for the purpose of iris registration.

Among acquired iris images, as shown in FIG. 21, each pixel of the acquired iris images is normalized into binary data to generate iris data for the iris images. That is, by normalizing the iris data into binary data indicating the presence of an iris pattern regardless of the darkness of the pattern, the amount of data may be reduced.

By processing the generated iris images into binary data to reduce the amount of data, it is possible to reduce a false-recognition rate through a change in path and a pattern of an iris in addition to improving a recognition rate. Furthermore, it is possible to improve miniaturization and portability because processing through a low-specification system is allowed, and it is also possible to increase a recognition rate regardless of the darkness of the pattern depending on time of day and lighting.

Also, as shown in FIG. 22, in the case of face recognition, an eye and peripheral muscle information detection step which is applied to embodiments of the present invention executes a preprocessing method for determining the locations of frontalis, corrugator supercilii, levator palpebrae, orbicularis oculi, and depressor supercilii, which are included in an eye muscle structure, detecting portions around eyes (eyebrows, eyelids, an area between eyes, a distance between an eye and a nose, a distance between an eye and a mouth, and angles of a nose and a mouth with respect to an eye) to generate default information to be used as registration or reference data, and preserving detailed features in a face image.

Subsequently, based on the eye location and the detailed surrounding information, a face image normalization step, a removal and statistical correction step for an external illumination component in a normalized face image, and a preprocessing and feature extraction step for extracting features from a preprocessed face image are performed.

In this case, the preprocessing and feature extraction step applied to embodiments of the present invention is to compensate for a change in external conditions such as brightness, posture, and expression. The brightness correction utilizes local variance normalization and local histogram smoothing.

FIG. 23 is a block diagram showing a network configuration of an electronic payment system providing an iris and/or face payment service according to embodiments of the present invention.

Referring to FIG. 23, an electronic payment system 2 using iris and/or face recognition of embodiments of the present invention may perform payment processing by recognizing an iris and/or a face such that electronic payments are made instead of customers' credit card payments or may perform payment processing through authentication of a customer's identity, that is, iris and/or face authentication when the customer makes an electronic payment through a conventional method, that is, a credit card, a debit card, a check card, and an account transfer.

To this end, the electronic payment system 2 of embodiments of the present invention includes a communication network 10, an iris and/or face payment service server 100, a plurality of customer clients 200, a credit card company server 300, and a plurality of affiliate clients 400.

The iris and/or face payment service server 100 has an iris and/or face payment app 110 for registering customers' iris and/or face information received from a corresponding customer client 200, authenticating the iris and/or face information upon payment. Through the iris and/or face payment app 110, an electronic payment is made over the communication network 10 among the customer client 200, a corresponding affiliate client 400, and the credit card company server 300.

The customer client 200 is provided as a mobile terminal that is easy to carry, for example, a smartphone, a tablet computer, and the like and includes an iris and/or face recognizer 210 to register or authenticate a customer's iris and/or face information. In this embodiment, the iris and/or face recognizer 210 may be provided inside the customer client 200 in the form of a module. Alternatively, the iris and/or face recognizer 210 may be provided as an independent device detachable from the customer client 200. The customer client 200 accesses the iris and/or face payment service server 100 over the communication network 10, downloads the iris and/or face payment app 110, and installs the iris and/or face payment app 110 therein.

Also, the customer client 200 activates the iris and/or face payment app 110, scans the customer's iris and/or face information through the iris and/or face recognizer 210, provides the scanned iris and/or face information to the iris and/or face payment service server 100 over the communication network 10, and registers the iris and/or face information to match a virtual payment means or payment device or payment substituted for the customer's credit card, for example, a virtual payment credit card, a virtual payment account, and the like.

It will be appreciated that the iris and/or face information of the customer client 200 registered in the iris and/or face payment service server 100 may be registered for identity verification and confirmation of a customer's pre-issued credit card, debit card, check card, and transaction account information.

The credit card company server 300 issues a virtual payment means or payment device or payment corresponding to the iris and/or face information of the customer client 200, determines whether to approve the payment using the iris and/or face information, and provides the determination result to the iris and/or face payment service server 100.

It will be appreciated that the credit card company server 300 may use the iris and/or face information of the customer client 200 for the purpose of the identity verification and confirmation of another payment means or payment device or payment corresponding to the customer client 200, for example, a credit card, a debit card, a check card, and transaction account information.

Also, the affiliate client 400 is a terminal provided in an affiliate store that sells a product or service through on- and off-line channels and includes, for example, a POS terminal, a personal computer (PC), and the like. The affiliate client 400 includes an iris and/or face recognizer 410 for recognizing a customer's iris and/or face information.

When the customer of the customer client 200 purchases a product or service at the affiliate store and makes a payment for the product or service, the affiliate client 400 scans the customer's iris and/or face information through the iris and/or face recognizer 410 and transmits the scanned iris and/or face information to the iris and/or face payment service server 100 over the communication network 10 to request approval of the payment. When the payment for the corresponding amount is approved by the credit card company server 300 (or another payment system), the affiliate client 400 confirms the payment approval through the iris and/or face payment service server 100.

Also, FIGS. 24 and 25 are flowcharts illustrating different examples of a processing procedure of a financial transaction relay system having a multiple safety lock function configured to process user authentication by scanning an iris and a face at the same time according to another embodiment of the present invention.

This embodiment is performed when user identification is difficult because the iris information and the face information are the same as or similar to their corresponding information. Primary user authentication is processed using the iris information. When the user identification is difficult through the primary user authentication, secondary user authentication is processed using the face information.

That is, referring to FIG. 24, the financial transaction relay system 2 of embodiments of the present invention scans a face and an iris by means of a face recognizer and an iris recognizer 210 of the customer terminal 200 at the same time and provides the face information and the iris information to the financial transaction relay server 100 in S180.

The financial transaction relay server 100 recognizes the iris information and the face information in S182 and compares the recognized iris information to iris information stored in a database 130 to determine whether the recognized iris information is unique in S184.

When the determination result is that the iris information is unique, the procedure proceeds to S188. When the iris information is not unique, that is, when the iris information is the same as or similar to the stored iris information and thus user identification is difficult, the financial transaction relay server 100 compares the face information to the face information stored in the database to determine whether the recognized face information is unique in S186.

When the determination result is that the face information is unique, the procedure proceeds to S188, and the financial transaction relay server 100 processes user authentication for releasing and blocking a firewall using at least one of a password and a phone number.

The financial transaction relay server 100 determines whether the password and/or phone number match a password and/or phone number stored in the database in S190. The financial transaction relay server 100 releases the firewall so that the multiple safety lock module may open the database of the financial transaction relay server through the middleware approval processing unit in S192. Subsequently, in S194, the financial transaction relay server 100 accesses the electronic financial transaction system or an e-commerce transaction system without authentication and relays a financial transaction.

However, when the customer terminal 200 cannot perform user authentication using the iris information and the face information in S186 or when the password and/or the phone number does not match the stored password and/or phone number in S190, this procedure proceeds to S196, and the access of the financial transaction relay server is blocked in order not to process the electronic financial transaction and the e-commerce transaction.

FIG. 25 is a flowchart in which a password and/or phone number input step (S188) is omitted. Since the iris recognition is possible only when a user is alive, the iris recognition is allowed only for the user, and thus the security is not affected even though the password or phone number process is omitted.

This embodiment is different from the above embodiment in that when both of the fingerprint and/or finger vein information and the iris information match corresponding ones after the iris recognition step S156, the procedure passes (S166) even when only one matches a corresponding one in the step of recognizing the fingerprint or the finger vein (S165), the financial transaction relay server releases its firewall so that the multiple safety lock module may open the database of the financial transaction relay server through the middleware approval processing unit in S168, and subsequently, in S170, the financial transaction relay server accesses an electronic financial transaction system or an e-commerce transaction system without authentication and relays a financial transaction.

However, when at least one of the fingerprint and/or finger vein information and the iris information received from the customer terminal 200 does not match the corresponding one in S158 and S166, this procedure proceeds to S172, and the financial transaction relay server blocks the access of the financial transaction relay server in order not to perform the electronic financial transaction and the e-commerce transaction.

The following description relates to an authentication card applied to the terminal of embodiments of the present invention, which is a credit card having a displayed ID photo and also an NFC function.

FIG. 26 shows an authentication card in which an ID photo is not displayed along with an NFC function operating due to a solar cell according to an embodiment of embodiments of the present invention, and FIG. 27 shows an authentication card in which an ID photo is displayed along with an NFC function operating due to a solar cell according to an embodiment of embodiments of the present invention.

As external elements of the authentication card 1800, a fingerprint scan module 1830 having a fingerprint recognition unit 1830a displayed thereon is formed on the front surface of the authentication card 1800, and a temperature sensor (not shown) or a blood flow sensor 1831 is formed on a lower end of the authentication card 1800 to sense the temperature or blood flow of a person during authentication. A solar cell module 1840 is formed on an upper portion of the authentication card 1800, and an emergency charging battery connected to the solar cell module 1840 is designed to charge or operate a power switching unit formed on one side (or on an upper side) in an emergency (this may be omitted when a power source is designed to be automatically turned on by a pressure sensor when constant current flows).

Also, a groove is formed in the central portion of the authentication card 1800, an ID photo 1810a is attached to the groove, and a shielding transparent LCD 1810 is attached thereon. When a fingerprint is scanned and the scanned fingerprint matches a stored fingerprint, the shielding transparent LCD 1810 is switched from an opaque state to a transparent state using power so that the ID photo 1810a (or default information) may be displayed as shown in FIG. 36.

Here, the fingerprint scan module 1830 or the shielding transparent LCD 1810 may be flexibly produced to increase the usability of the authentication card.

In particular, a finger part of the fingerprint scan module 1830 is concave so that the entire fingerprint can be brought into contact with the finger part, thereby further increasing a fingerprint recognition rate.

The following description relates to the construction of a server for storing fingerprint and finger vein information (hereinafter, an element having the same concept as “iris and face information” will be described).

FIG. 28 is a flowchart illustrating a processing procedure of another electronic payment system according to embodiments of the present invention, FIG. 29 is a diagram showing an internal electronic configuration of a fingerprint and/or finger vein capture authentication device according to a preferred embodiment of the present invention, FIG. 30 is an organization diagram for bank classification according to embodiments of the present invention, and FIG. 31 is an organization diagram for classification based on gender and age by decade according to embodiments of the present invention.

The fingerprint and/or finger vein payment service server 100 of embodiments of the present invention (hereinafter, a server having the same concept as “iris and face information” will be described) receives fingerprint and/or finger vein information from the customer client 200 over a communication network and registers the received fingerprint and/or finger vein information in the database. When a customer's fingerprint and/or finger vein information and payment request is received from the affiliate client 400, the fingerprint and/or finger vein payment service server 100 conducts an analysis by comparing the received fingerprint and/or finger vein information to the registered fingerprint and/or finger vein information. When the fingerprint and/or finger vein information corresponds to a specific customer, the fingerprint and/or finger vein payment service server 100 requests the credit card company server 300 to approve the payment such that the payment is made by the corresponding customer's payment means or payment device or payment. When the payment is approved by the credit card company server 300, the fingerprint and/or finger vein payment service server 100 informs the customer client 200 and the affiliate client 400 that the payment is made.

FIG. 28 is a flowchart illustrating a processing procedure of an electronic financial payment system according to embodiments of the present invention.

The procedure is a program processed by the fingerprint and/or finger vein payment service server 100 according to embodiments of the present invention. This program is provided as a fingerprint and/or finger vein payment app, stored in a storage unit (not shown) of the fingerprint and/or finger vein payment service server 100, and installed in the customer client 200. A fingerprint and/or finger vein payment hybrid web 202 is processed in cooperation with the customer client 200, the affiliate client 400, the credit card company server 300, and/or the fingerprint and/or finger vein payment service server 100.

Referring to FIGS. 23 and 28 (a technique for authenticating information on irises, faces, fingerprints, and finger veins will be equally described), the electronic payment system of embodiments of the present invention provides a fingerprint and/or finger vein payment hybrid web 202 to the fingerprint and/or finger vein payment service server 100 in S150. In S152, the customer client 200 accesses the fingerprint and/or finger vein payment service server 100 over the communication network 10, downloads the fingerprint and/or finger vein payment hybrid web 202, and installs the downloaded fingerprint and/or finger vein payment hybrid web 202 therein.

In S152a, banks are classified and then registered. However, as shown in FIG. 30, the banks are classified into a primary lender 1301, a secondary lender 1302, a credit card 1303, a securities company 1304, an insurance company 1305, and an e-commerce company 1306, and a main bank is selected from the various types of banks by a customer upon registration.

In S153 as shown in FIG. 31, when customer gender information is registered, men are registered with “1” and women are registered with “2.”

Subsequently, in S153a, after the gender of the customer client is registered, the age of the customer client by decade is classified and registered according to his or her age.

In S154, the customer client 200 activates the installed fingerprint and/or finger vein payment hybrid web 202, acquires the customer's fingerprint and/or finger vein information through the fingerprint and/or finger vein recognizer 210, and provides the acquired fingerprint and/or finger vein information to the fingerprint and/or finger vein payment service server 100 over the communication network 10.

In S156, the fingerprint and/or finger vein payment service server 100 stores and registers the bank information, the gender and age-by-decade information, and/or the fingerprint and/or finger vein information provided from the customer client 200 in the database. In this case, the fingerprint and/or finger vein payment service server 100 transmits gender information and fingerprint and/or finger vein information to the credit card company server 300 over the communication network 10.

In S157, the bank information and the customer gender information are determined based on the registered male information “1” and female information “2” and then based on the age by decade.

In S158, the credit card company server 300 registers the fingerprint and/or finger vein information transmitted from the fingerprint and/or finger vein payment service server 100 to match the customer's payment means or payment device or payment registered in the credit card company server 300 or registers the fingerprint and/or finger vein information to match a credit card, a debit card, a check card, a transaction account, and the like pre-issued by the credit card company server 300. Accordingly, in the above steps S150 to S158, the customer client 200 is registered to enable electronic payment processing of the fingerprint and/or finger vein information.

In S159, when a commercial transaction occurs in an affiliate store, the bank information and the customer gender information is determined based on the registered male information “1” and female information “2” and then based on the age by decade.

In S160, the customer's fingerprint and/or finger vein information is recognized from the fingerprint and/or finger vein recognizer of the affiliate client 400. In S162, the fingerprint and/or finger vein information and payment information are transmitted to the fingerprint and/or finger vein payment service server 100 to request the fingerprint and/or finger vein payment service server 100 to approve a payment corresponding to the commercial transaction.

In S164, the fingerprint and/or finger vein payment service server 100 conducts an analysis by comparing the fingerprint and/or finger vein information transmitted from the affiliate client 400 to the fingerprint and/or finger vein information registered in the database to determine the customer's authentication state. In S166, when the determination result is that the transmitted fingerprint and/or finger vein information matches the registered fingerprint and/or finger vein information, the fingerprint and/or finger vein payment service server 100 requests the credit card company server 300 to approve a payment such that the payment is made by the corresponding customer's payment means or payment device or payment. When the determination result is that the transmitted fingerprint and/or finger vein information does not match the registered fingerprint and/or finger vein information, the fingerprint and/or finger vein payment service server 100 informs the affiliate client 400 of rejection of the approval, a reason for the rejection, and the like.

In S168, when the payment is approved through a payment means or payment device or payment corresponding to the fingerprint and/or finger vein information requested for the payment, the credit card company server 300 informs the affiliate client 400 and the fingerprint and/or finger vein payment service server 100 that the payment is approved. In S170, the fingerprint and/or finger vein payment service server 100 transmits the payment approval result to the customer client 200. In S172, the affiliate client 400 confirms that the payment is approved. In S174, the customer client 200 confirms that the payment is approved.

Accordingly, an electronic payment system using fingerprint and/or finger vein authentication of embodiments of the present invention registers the customer's fingerprint and/or finger vein information in the fingerprint and/or finger vein payment service server 100. Thus, when a commercial transaction occurs from the affiliate client 400, the electronic payment system determines the fingerprint and/or finger vein information and performs processing so that the payment is made through a payment means or payment device or payment matching the customer's fingerprint and/or finger vein information.

Also, the database stores customer information classified based on gender and age by decade, fingerprint and/or finger vein information, bank classification information, credit card matching information, payment information, and affiliate information. In particular, the customer gender information is classified and registered based on “1” for men and “2” for women, and the bank information or the customer information is registered in the customer client 200 or the affiliate client 400 and then determined. Thus, it is possible to reduce the probability of misrecognition of embodiments of the present invention by a factor of several dozens.

FIG. 29 shows an internal electronic configuration of a fingerprint and/or finger vein capture authentication device according to embodiments of the present invention.

The integrated capture authentication device of embodiments of the present invention includes an infrared light source 1240, a finger vein image sensor 1230, a fingerprint image sensor 1220, a digital conversion unit 1290, a decryption algorithm unit 1260, a bank classification registration unit 1265a, a gender identification processing unit 1265, a age-by-decade classification registration unit 1265b, biometric information data storage 1270, and a display unit 1280.

Also, although not shown in the drawing, the integrated capture authentication device may include a power supply unit, a communication unit, and various I/O devices.

The infrared light source 1240 emits infrared light toward an object housing unit. The infrared light source 1240 may emit infrared light having a wavelength of 630 nm to 1,000 nm which is suitable for capturing a finger vein image and may be composed of one or more light emitting diodes (LEDs). Also, an optical filter may be installed to remove optical noise.

A visible light source emits visible light toward an object housing unit. The visible light source may be composed of one or more LEDs by emitting ultraviolet light of a wavelength suitable for capturing a fingerprint of a finger surface.

Also, in some embodiments of the present invention, an infrared light source for emitting infrared light toward the object housing unit and a visible light source for emitting visible light toward the object housing unit may be installed.

In a preferred embodiment of the present invention, a fingerprint image sensor 1220 or a finger vein image sensor 1230 acquires a finger vein image for one finger object from a lower portion and a side portion.

In a preferred embodiment of the present invention, the finger vein image sensor 1230 acquires a finger vein image of a side surface and a fingerprint surface of one finger object.

When a front image of the finger object is captured, the fingerprint surface of the finger is put on a scan panel and then captured. Depending on the number of fingerprint image sensors 1220 or finger vein image sensors 1230, the side surface is brought into contact with the scan panel by rolling the finger 90 degrees sideways when a side image is captured. The capture order of the fingerprint surface and the side surface of the finger may be changed.

The digital conversion unit 1290 receives the fingerprint and finger vein image and the fingerprint image and extracts a finger vein and fingerprint image from the fingerprint and finger vein image and the fingerprint image. According to embodiments of the present invention, a finger vein and fingerprint image file of the finger is obtained by the digital conversion unit 1290.

The control unit 1210 delivers image files, which are obtained through conversion by the digital conversion unit 1290, to the matching algorithm unit 1260.

The biometric information data storage 1270 stores biometric information of users in advance. In some embodiments of the present invention, the biometric information data storage 1270 may be built in a memory inside an authentication device.

The biometric information data storage 1270 may use a crypto-processor capable of being protected from thefts or external hardware or software attacks.

The matching algorithm unit 1260 acquires user data stored in the biometric information data storage 1270 and then determines whether the acquired user data matches a user's biometric information value acquired by the digital conversion unit 1290. When the user data matches the biometric information value, a success message may be output through the display unit 1280. When the decryption fails, the display unit 1280 may output an authentication failure message.

As shown in FIG. 30, the bank classification registration unit 1265a classifies a bank classification table 1300 into a primary lender 1301, a secondary lender 1302, a credit card 1303, a securities company 1304, an insurance company 1305, and an e-commerce company 1306 and selects a main bank from the various types of banks upon registration.

That is, when a customer loads a banking section, selects a primary lender, and selects “Shinhan Bank” as a payment method, the customer may make a payment through a desired bankbook. Even when a card is selected, the customer may select a desired card and make a payment using the selected card.

Also, as shown in FIG. 29, the gender identification processing unit 1265 functions to classify and register male information as “1” and female information as “2” upon authentication of both of the fingerprint and the finger vein.

As shown in FIG. 31, the age-by-decade classification registration unit 1265b classifies and registers a gender and age-by-decade classification table 1400 based on male 1401 and female 1402 and based on decades.

The control unit 1210 controls the operation and function of the authentication device. In particular, the control unit 1210 determines the acquisition, processing, authentication computation, and authentication result of a fingerprint and/or finger vein image. The control unit 1210 may use various software applications to process and compute the acquired fingerprint and/or finger vein image.

For example, the control unit 1210 may use the Canny edge detector algorithm.

Also, the control unit 1210 may remove all noise of an original image by applying a Gaussian filter. The control unit 1210 edges the image through an image gradient. That is, the control unit 1210 extracts sketch lines in the image. The control unit 1210 carries out a task of making an edge (sketch line) thin by applying non-maximum suppression and applies double thresholds to classify dark edges as solid edges and classify faint edges as weak edges by regarding the weak edges as noise. Also, the control unit 1210 deletes the weak edges, leaves only the solid edges, and finally outputs the edged image of the finger vein.

Accordingly, in a processing method of an electronic payment system using fingerprint and/or finger vein recognition, information indicating “1” for men and “2” for women as gender identification information may be optionally input when an app is downloaded from the electronic payment system and a fingerprint and/or a finger vein are registered. Since the method of identifying the gender or recognizing the fingerprint and/or finger vein is carried out in a mobile device itself, a consumer may own the mobile device and thus may easily register, authenticate, and use the mobile device. Accordingly, it is possible to fundamentally block others from imitation or theft.

Furthermore, the authentication device of embodiments of the present invention can drastically reduce a false-recognition rate by utilizing and authenticating, for example, both of finger vein data and a fingerprint image of a finger.

The following description relates to a technique for registration and authentication processing for fingerprint and finger vein information applied to a hybrid web associated with a smartphone.

FIG. 32 is a block diagram showing configurations of a customer client and a smartphone.

In this embodiment, the customer client is provided as a smartphone 200 to access the fingerprint and/or finger vein payment hybrid web 202. The fingerprint and/or finger vein payment hybrid web 202 accesses the fingerprint and/or finger vein payment service server 100 over a communication network.

The smartphone 200 activates the fingerprint and/or finger vein payment hybrid web 202 and registers the customer's fingerprint and/or finger vein information in the fingerprint and/or finger vein payment service server 100. To this end, the fingerprint and/or finger vein recognizer 210 is attached to the smartphone 200. In order to eliminate the economic burden on a customer who will purchase the fingerprint and/or finger vein recognizer 210 and to actively encourage the use of the fingerprint and/or finger vein payment hybrid web 202, the fingerprint and/or finger vein recognizer 210 is provided at a commercial site by a credit card company, an affiliate store, and a service provider of the fingerprint and/or finger vein payment service server 100. When a payment means or payment device or payment using a fingerprint and/or a finger vein is registered and used, the fingerprint and/or finger vein recognizer 210 is provided detachably from the smartphone 200.

The fingerprint and/or finger vein recognizer 210 acquires finger vein information to authenticate a customer by projecting near-infrared rays to a vein of a finger which is easy to use among the blood vessels of the customer and recognizing the hemoglobin pattern of the vein. That is, by emitting near-infrared light to the finger and capturing the finger by means of a scanner having near-infrared sensitivity, for example, an infrared camera using absorption of near-infrared light in the vein of the finger and transmission of near-infrared light in a portion other than the vein, the fingerprint and/or finger vein recognizer 210 may capture the picture of the vein, extract a pattern of the vein, and thus use the extracted pattern to perform personal authentication.

In detail, the fingerprint and/or finger vein recognizer 210 includes a controller 212 configured to control the overall operation of the fingerprint and/or finger vein recognizer 210, a scanner 214 configured to scan a customer's finger to acquire fingerprint and/or finger vein information, a memory 216 configured to store the fingerprint and/or finger vein information acquired by the scanner 214, an LCD 218 configured to display the fingerprint and/or finger vein information scanned by the scanner 214 or display a processing process of the fingerprint and/or finger vein recognizer 210, and an interface module 220 connected to the smartphone 200 and configured to provide the fingerprint and/or finger vein information acquired by the scanner 214 to the smartphone 200.

In addition, the fingerprint and/or finger vein recognizer 210 further includes a temperature sensor 222 configured to sense the temperature of the finger when the fingerprint and/or finger vein information is acquired by the scanner 214 and a blood flow recognition sensor 224 configured to recognize blood flowing through the finger. In order to supplement and solve a problem with the temperature sensor 222 and the blood flow recognition sensor 224 being capable of scanning fingerprint and/or finger vein information using only another person's finger for a certain time, the fingerprint and/or finger vein recognizer 210 recognizes the temperature of the finger and the flow of blood along with the fingerprint and/or finger vein information acquired by the scanner 214 and provides the fingerprint and/or finger vein information acquired by the scanner 214 to the smartphone 200 when there is no abnormality.

The fingerprint and/or finger vein recognizer 210 has the same or similar configuration to the fingerprint and/or finger vein recognizer of the affiliate client 400. Accordingly, the description of a detailed configuration or function of the fingerprint and/or finger vein recognizer of the affiliate client 400 will be omitted.

Also, as can be seen from the flowchart illustrating the processing procedure of the electronic payment system according to embodiments of the present invention with reference to FIG. 41, the fingerprint and finger vein payment hybrid web 202 is a program processed by the fingerprint and/or finger vein payment service server 100 according to embodiments of the present invention. The program interoperates with the fingerprint and/or finger vein payment hybrid web. The program is stored in a storage unit (not shown) of the fingerprint and/or finger vein payment service server 100 and installed in the customer client 200.

The fingerprint and/or finger vein payment hybrid web 202 is processed in cooperation with the customer client 200, the affiliate client 400, the credit card company server 300, and the fingerprint and/or finger vein payment service server 100, and the procedure overlapping with that described with reference to FIG. 28 will be omitted.

As described above, the POS terminal of embodiments of the present invention may perform a financial transaction using human body information. As a payment method, a finger payment may be made by the fingerprint and finger vein authentication device, a payment may be made without authentication by transmission of NFC communication signals using a fingerprint card, and a payment may be made by a fingerprint, a finger vein, an iris, and face information registered in bank and card information through the hybrid web. The bank and card information is classified on a bank basis, on a gender basis, and on a age-by-decade basis and then stored in a server. The selection of the authentication card and the payment with the authentication card are separated from each other, and thus it is possible to increase the payment processing rate.

The following description relates to an embodiment of an integrated biometric authentication terminal connected to a connection unit of a sign-pad to perform a separate independent function in a conventional POS terminal of embodiments of the present invention.

FIG. 33 is a schematic perspective view of an integrated biometric authentication terminal separated from the POS terminal of embodiments of the present invention, FIG. 34 is a diagram of an operating procedure of an integrated biometric authentication terminal of embodiments of the present invention, and FIG. 35 is a usage amount status table checked in the integrated biometric authentication terminal of embodiments of the present invention.

As shown in the drawing, the integrated biometric authentication terminal 1000a separated from the conventional POS terminal has a magnetic card check unit 1102 formed on one side and an IC card check unit 1190b formed in the front central portion of the body, starts when the power supply unit 1110a is turned on, and displays a payment amount on an LCD display unit through a data input unit connected to the conventional POS terminal. When a final payment button is pressed, final identity verification is made.

Also, the electronic cover 1150 is formed on the front portion of the integrated biometric authentication terminal 1000a in order to design a payment system. The fingerprint and/or finger vein authentication processing unit 1180 for only one finger is formed on one side, and the card information authentication processing unit 1190 is formed in the central portion. The card information authentication processing unit 1190 may have an authentication card tag unit and a smartphone tag unit formed such that a card or the like may be used for payment. When the authentication card tag unit and the smartphone tag unit have functions capable of being integrated with each other or the same function, a single guide display unit may be devised.

Also, the fingerprint authentication processing unit 1181 is formed on one side of the electronic cover 1150 and is formed for a user who is authenticated and registered simply using only a fingerprint.

The fingerprint authentication processing unit 1181 may be independently installed. Also, a customer LCD display unit 1199a is formed in an upper portion of the electronic cover 1150 by a hinge 1151a such that angle adjustment is possible according to a customer's location, and a customer's payment amount and a sign of appreciation are displayed on the customer LCD display unit 1199a. In addition, an advertisement function is additionally operated.

Also, an iris information authentication processing unit 1194 is formed on an upper end of the customer LCD display unit 1199a, and a face information authentication processing unit 1196 is designed and formed along with the iris information authentication processing unit 1194.

Furthermore, the electronic cover 1150 has a password input button 1120a for a 10-digit number formed on an upper end and used when a password is requested after fingerprint authentication, a usage amount confirmation button 1120b formed on one side to confirm an amount used by a user, and a password modification input button 1120c formed on another side and used to modify a password.

A wireless electric charger 1190a capable of charging a card with electricity in a wireless manner is formed on a lower end of the password input button 1120a to supply power to the card when the fingerprint recognition card is brought into contact with the wireless electric charger 1190a.

Also, the main body connection jack 1119b capable of being connected to the integrated terminal of the main body may be formed behind the integrated biometric authentication terminal 1000a.

Reference number 1182 indicates an infrared transmission unit 1182 configured to additionally perform transmission in the fingerprint and finger vein authentication processing unit 1180.

The following description relates to the operating procedure of the integrated biometric authentication terminal of embodiments of the present invention.

FIG. 34 is a flowchart illustrating a different example of a processing procedure of a financial transaction relay system having a multiple safety lock function configured to process user authentication by scanning an iris and a face at the same time according to another embodiment of the present invention.

This embodiment is performed when user identification is difficult because the fingerprint information and the face information are the same as or similar to their corresponding information. Primary user authentication is processed using the fingerprint information. When it is determined through the primary user authentication that there are two or more corresponding users, user authentication is processed by entering their phone numbers (or a password).

First, in the initial step, the integrated biometric authentication terminal is turned on to access the whole system (S1211).

In the financial transaction relay system of embodiments of the present invention, the customer terminal accesses the financial transaction relay server over the communication network in S1211 and signs up for membership in S1212.

In this case, a customer's personal information such as a name, an ID, a password, a phone number, and an email address is entered through the customer terminal.

Here, the signing up for membership is performed using a smartphone or directly through a bank or a card company (S1212).

Subsequently, a registration request is made by the face and iris recognizer and the fingerprint and/or finger vein recognizer as a step of registering a face, an iris, a fingerprint, and a finger vein upon the signing up for membership (S1213).

In the above step, when biometric information is acquired and transmitted to the financial transaction relay server over the communication network, the financial transaction relay server registers the information to correspond to the customer terminal. In this case, the financial transaction relay server stores the biometric information in the database.

Subsequently, the biometric information is selectively scanned with relation to the user by the iris information authentication processing unit 1194, the face information authentication processing unit 1196, the fingerprint and finger vein authentication processing unit 1180, and the fingerprint authentication processing unit 1181 formed in the integrated biometric authentication terminal 1000a (S1214).

Also, in order to perform an electronic financial transaction and an e-commerce transaction, the financial transaction relay server primarily recognizes the selectively entered biometric information upon connection of financial information for payment (bankbook or card) (S1215).

Here, the financial transaction relay server determines whether the selectively entered biometric information matches the selected biometric information stored in the database and performs a processing procedure for authenticating the user of the customer terminal.

First, the financial transaction relay server determines whether the selected human body information and fingerprint information stored in the database are unique, that is, whether there are two or more pieces of the same fingerprint information (S1216).

When the determination result is that there are two or more pieces of the same fingerprint information, any one of a password and a phone number registered for the user is entered (S1217). When the fingerprint information is unique and thus two pieces of the human body information match each other, one piece of the financial information (bankbook or card) is selected (S1218).

Here, it is assumed that the duplication probability of the fingerprint information is one in one billion. In this case, when only a four-digit password is input, the duplication probability decreases drastically, and the financial information is stored and managed on a bank basis, on an age basis, and on a gender basis for the purpose of server speed.

The financial information is classified into selection of a bank capable of using a bankbook and selection of a card company capable of using a card and displayed on the customer LCD display unit 1199a. The selection is made by a user's touch with a finger (S1219).

Subsequently, when the bankbook or card is selected (S1219), a payment amount is entered (S1220).

When a payment amount used by a customer is entered, the face information authentication processing unit 1196, which has been waiting, captures the customer's face (S1221) and determines whether the captured face matches its corresponding information (S1222).

When the captured face matches its corresponding information, a phone number (or a password or biometric information) is entered (S1223).

Subsequently, whether the entered phone number (or password or biometric information) matches a phone number (or a password or biometric information) stored in the database is determined (S1224).

Last, when the entered phone number matches the stored phone number in the above step, a predetermined procedure is terminated, and a withdrawal is made (S1225).

In this case, the access is blocked (S1226) when the two pieces of information are not the same in each step.

The following description relates to a usage amount status table 3288 displayed on the customer LCD display unit 1199a in the integrated biometric authentication terminal 1000a.

The usage amount status table 3288 may show a date and time 3288a, a user name 3288b, an approval (cancellation) number 3288c, and an amount 3288d and may allow a daily sum 3288e, a monthly sum 3288f, and a yearly sum 3288g.

When such a usage amount status table 3288 is used, a store's trading performance may be checked at any time. Also, the approval (cancellation) number 3288c may be allowed to be used when there is a correction or a cancellation, for example, an error in a transaction amount caused by a clerk or a change of a payment means or payment device or payment for a transaction amount caused by a user.

As described above, the biometric information includes a face, an iris, a voice, a fingerprint, a finger vein, and the like. However, by employing a method of recognizing a fingerprint first and then recognizing face information later to initiate the procedure through the touch of a smartphone with a finger and capture a face with a camera of the smartphone while selecting a bankbook or card for payment to prepare to authenticate face information, it is possible to actually facilitate identity verification based on human body information.

Also, a smartphone structurally has a face recognition function as well as a fingerprint recognition function. Therefore, by just developing a program capable of organically operating these functions, the security is strengthened by convergence authentication, and thus even without a bankbook or card, financial transactions can be allowed only through a user's biometric authentication.

The following description relates to a method of displaying a user's face photo upon finger authentication before selecting financial information in the integrated biometric authentication terminal according to another embodiment of the present invention. FIG. 36 is a diagram showing a state in which a user's face photo is displayed on both of a clerk terminal and a customer terminal upon finger authentication in the final payment step or before financial information is selected in an integrated terminal of embodiments of the present invention, FIG. 37 is a diagram showing a coupling state with a conventional terminal in which a user's face photo is displayed upon finger authentication in the final payment step or before financial information is selected in an integrated biometric authentication terminal of embodiments of the present invention, FIG. 38 is a diagram showing an operating procedure in which a user's face photo is displayed upon finger authentication before financial information is selected in an integrated biometric authentication terminal of embodiments of the present invention, and FIG. 39 is a diagram showing an operating procedure in which a user's face photo is displayed upon finger authentication in the final payment step or before financial information is selected in an integrated biometric authentication terminal of embodiments of the present invention.

FIG. 36 shows that a photo applied to an integrated terminal of embodiments of the present invention is displayed, and FIG. 37 shows that a photo displayed on an LCD display unit upon finger authentication while the conventional POS terminal is coupled to the integrated biometric authentication terminal of embodiments of the present invention. Other elements have been described above, and thus a description thereof will be omitted.

A first embodiment of the present invention associated with the displaying of a face photo is performed when user identification is difficult because the fingerprint information and the face information are the same as or similar to their corresponding information. Primary user authentication is processed using the fingerprint information. When it is determined through the primary user authentication that there are two or more corresponding users, user authentication is processed by entering their phone numbers (or a password).

First, in the initial step, the integrated biometric authentication terminal is turned on to access the whole system (S1211).

In the financial transaction relay system of embodiments of the present invention, the customer terminal accesses the financial transaction relay server over the communication network in S1211 and signs up for membership in S1212.

In this case, a customer's personal information such as a name, an ID, a password, a phone number, and an email address is entered through the customer terminal.

Here, the signing up for membership is performed using a smartphone or directly through a bank or a card company (S1212).

Subsequently, a registration request is made by the face and iris recognizer and the fingerprint and/or finger vein recognizer as a step of registering a face, an iris, a fingerprint, and a finger vein upon the signing up for membership (S1213).

In the above step, when biometric information is acquired and transmitted to the financial transaction relay server over the communication network, the financial transaction relay server registers the information to correspond to the customer terminal. In this case, the financial transaction relay server stores the biometric information in the database.

Subsequently, the biometric information is selectively scanned for the user by the iris information authentication processing unit 1194, the face information authentication processing unit 1196, the fingerprint and finger vein authentication processing unit 1180, and the fingerprint authentication processing unit 1181 formed in the integrated biometric authentication terminal 1000a (S1214).

Also, in order to perform an electronic financial transaction and an e-commerce transaction, the financial transaction relay server primarily recognizes the selectively entered biometric information upon connection of financial information for payment (bankbook or card) (S1215).

Here, the financial transaction relay server determines whether the selectively entered biometric information matches the selected biometric information stored in the database, and performs a processing procedure for authenticating the user of the customer terminal.

When the fingerprint and/or finger vein information of the user matches stored information in the fingerprint authentication processing unit 1181 or the fingerprint and/or finger vein authentication processing unit 1180 (S1215a), the financial transaction relay server displays an ID photo 1810a on the customer LCD display unit 1199a formed in the integrated biometric authentication terminal 1000a and/or on the clerk LCD display unit 1130 formed in the POS terminal (S1215b).

When the fingerprint and/or finger vein information of the user does not match the stored information, the financial transaction relay server blocks the access (S1226).

Subsequently, the financial transaction relay server determines whether the selected human body information and fingerprint information stored in the database are unique, that is, whether there are two or more pieces of the same fingerprint information (S1216).

When the determination result is that there are two or more pieces of the same fingerprint information, any one of a password and a phone number registered for the user is entered (S1217). When the fingerprint information is unique and thus two pieces of the human body information match each other, one piece of the financial information (bankbook or card) is selected (S1218).

Here, it is assumed that the duplication probability of the fingerprint information is one in one billion. In this case, when only a four-digit password is input, the duplication probability decreases drastically, and the financial information is stored and managed on a bank basis, on an age basis, and on a gender basis for the purpose of the server speed.

The financial information is classified into selection of a bank capable of using a bankbook and selection of a card company capable of using a card and displayed on the customer LCD display unit 1199a. The selection is made by a user's touch with a finger (S1219).

Subsequently, when the bankbook or card is selected (S1219), a payment amount is entered (S1220).

When a payment amount used by a customer is entered, the face information authentication processing unit 1196, which has been waiting, captures his or her face (S1221) and determines whether the captured face matches its corresponding information (S1222).

When the captured face matches its corresponding information, a phone number (or a password or biometric information) is entered (S1223).

Subsequently, whether the entered phone number (or password or biometric information) matches a phone number (or a password or biometric information) stored in the database is determined (S1224).

Last, when the entered phone number matches the stored phone number in the above step, a predetermined procedure is terminated, and a withdrawal is made (S1225).

In this case, the access is blocked (S1226) when the two pieces of information are not the same in each step.

A second embodiment of the present invention associated with the displaying of a face photo is performed when user identification is difficult because the fingerprint information and the face information are the same as or similar to their corresponding information. Primary user authentication is processed using the fingerprint information. When it is determined through the primary user authentication that there are two or more corresponding users, user authentication is processed by entering their phone numbers (or a password).

First, in the initial step, the integrated biometric authentication terminal is turned on to access the whole system (S1211).

In the financial transaction relay system of embodiments of the present invention, the customer terminal accesses the financial transaction relay server through the communication network in S1211 and signs up for membership in S1212.

In this case, a customer's personal information such as a name, an ID, a password, a phone number, and an email address is entered through the customer terminal.

Here, the signing up for membership is performed using a smartphone or directly through a bank or a card company (S1212).

Subsequently, a registration request is made by the face and iris recognizer and the fingerprint and/or finger vein recognizer as a step of registering a face, an iris, a fingerprint, and a finger vein upon the signing up for membership (S1213).

In the above step, when biometric information is acquired and transmitted to the financial transaction relay server over the communication network, the financial transaction relay server registers the information to correspond to the customer terminal. In this case, the financial transaction relay server stores the biometric information in the database.

Subsequently, the biometric information is selectively scanned for the user by the iris information authentication processing unit 1194, the face information authentication processing unit 1196, the fingerprint and finger vein authentication processing unit 1180, and the fingerprint authentication processing unit 1181 formed in the integrated biometric authentication terminal 1000a (S1214).

Also, in order to perform an electronic financial transaction and an e-commerce transaction, the financial transaction relay server primarily recognizes the selectively entered biometric information upon connection of financial information for payment (bankbook or card) (S1215).

Here, the financial transaction relay server determines whether the selectively entered biometric information matches the selected biometric information stored in the database and performs a processing procedure for authenticating the user of the customer terminal.

When the fingerprint and/or finger vein information of the user matches stored information in the fingerprint authentication processing unit 1181 or the fingerprint and/or finger vein authentication processing unit 1180 (S1215a), an ID photo 1810a is displayed on the customer LCD display unit 1199a formed in the integrated biometric authentication terminal 1000a and/or the clerk LCD display unit 1130 formed in the POS terminal (S1215b).

When the fingerprint and/or finger vein information of the user does not match the stored information, the access is blocked (S1226).

Subsequently, the financial transaction relay server determines whether the selected human body information and fingerprint information stored in the database are unique, that is, whether there are two or more pieces of the same fingerprint information (S1216).

When the determination result is that there are two or more pieces of the same fingerprint information, any one of a password and a phone number registered for the user is entered (S1217). When the fingerprint information is unique and thus two pieces of the human body information match each other, one piece of the financial information (bankbook or card) is selected (S1218).

Here, it is assumed that the duplication probability of the fingerprint information is one in one billion. In this case, when only a four-digit password is input, the duplication probability decreases drastically, and the financial information is stored and managed on a bank basis, on an age basis, and on a gender basis for the purpose of the server speed.

The financial information is classified into selection of a bank capable of using a bankbook and selection of a card company capable of using a card and displayed on the customer LCD display unit 1199a. The selection is made by a user's touch with a finger (S1219).

Subsequently, when the bankbook or card is selected (S1219), a payment amount is entered (S1220).

When the fingerprint and/or finger vein information of the user matches stored information in the fingerprint authentication processing unit 1181 or the fingerprint and/or finger vein authentication processing unit 1180 (S1222), an ID photo 1810a is displayed on the customer LCD display unit 1199a formed in the integrated biometric authentication terminal 1000a and/or the clerk LCD display unit 1130 formed in the POS terminal (S1223).

Last, when the entered phone number matches the stored phone number in the above step, a predetermined procedure is terminated, and a withdrawal is made (S1225).

In this case, the access is blocked (S1226) when the two pieces of information are not the same in each step.

The following description relates to a usage amount status table 3288 displayed on the customer LCD display unit 1199a in the integrated biometric authentication terminal 1000a applicable to both of the first embodiment and the second embodiment.

The usage amount status table 3288 may show a date and time 3288a, a user name 3288b, an approval (cancellation) number 3288c, and an amount 3288d and may allow a daily sum 3288e, a monthly sum 3288f, and a yearly sum 3288g to be shown.

When such a usage amount status table 3288 is used, a store's trading performance may be checked at any time. Also, the approval (cancellation) number 3288c may be allowed to be used when there is a correction or a cancellation, for example, an error in a transaction amount caused by a clerk or a change of a payment means or payment device or payment for a transaction amount caused by a user.

As described above, the biometric information includes a face, an iris, a voice, a fingerprint, a finger vein, and the like. However, a method of recognizing a fingerprint first and then recognizing face information later is employed to actually facilitate identity verification based on human body information by touching a smartphone with a finger to initiate the procedure, capturing a face with a camera of the smartphone while selecting a bankbook or card for payment, and preparing to authenticate face information.

Also, a smartphone structurally has a face recognition function as well as a fingerprint recognition function. Therefore, by just developing a program capable of organically operating these functions, the security is strengthened by convergence authentication, and thus even without a bankbook or card, financial transactions can be allowed only through a user's biometric authentication.

The following description relates to an advertisement method using the POS terminal of embodiments of the present invention.

FIG. 40 is a diagram showing an advertisement execution procedure performed by a customer LCD display unit applied to the integrated payment device using the POS terminal of embodiments of the present invention, and FIG. 41 is a diagram showing an additional advertisement execution procedure performed by the customer LCD display unit applied to the integrated payment device using the POS terminal of embodiments of the present invention.

In the advertisement method of embodiments of the present invention, a POS terminal 1000 has a cuboid shape, has a magnetic card check unit 1102 formed on one side and an IC card check unit 101 formed in a lower portion, starts when a power supply unit 1110 is turned on, and displays a payment amount on a clerk LCD display unit 1130 through a data input unit 1120 so that a final payment button may be pushed. An electronic cover 1150 is formed, as a customer payment system, on the front surface opposite to the clerk LCD display unit 1130 of the POS terminal 1000. The electronic cover 1150 has a fingerprint and finger vein authentication processing unit 1180 formed on one side to perform authentication processing with a finger and a card information authentication processing unit 1190 formed on the other side to perform authentication processing with a customer's card information. Also, the customer LCD display is formed on the electronic cover 1150 to execute a three-second instant advertisement video upon payment with a fingerprint and/or a finger vein and/or upon payment with a card.

In the advertisement method using the POS terminal of embodiments of the present invention, first, an advertisement switch of the POS terminal is turned on as a step of turning on the advertisement switch of the POS terminal (S300).

When the advertisement switch of the POS terminal is turned on, general thirty-second short videos are consecutively executed to display an advertisement on customer LCD display units 1199a and 1199b while calling a user's attention as a thirty-second advertisement video step in which a general thirty-second short advertisement video is displayed on the customer LCD display units 1199a and 1199b (S301).

Also, a clerk enters a payment amount such that an amount charged to the customer is displayed on the customer LCD display unit as the payment amount as a payment amount input step in which a payment amount is entered and then displayed on the customer LCD display unit (S302).

When the payment amount is entered, the general advertisements are stopped, and the payment is displayed on the customer LCD display unit as a step of stopping an advertisement and displaying the payment amount on the customer LCD display unit (S303).

Also, the POS terminal informs the customer of a payment method using a voice (or text) as a payment amount informing step in which the customer is informed about a payment method with a voice (or text) (S304).

The customer selects a desired payment method (human body information or card information) and executes a payment as a payment execution step in which the customer selects a desired payment method (human body information or card information) and makes a payment (S305).

When the charged amount is paid, a three-second instant advertisement is executed during confirmation of the payment as a three-second instant advertisement execution step (S306).

When the three-second instant advertisement is terminated, the payment is fully complete as a three-second instant advertisement termination step (S307).

As an advertisement repeating step, when an advertising behavior is curious or exciting, the customer may touch the human body information or the card information once more (S308). In this case, the three-second instant advertisement video may be further executed (S309).

Accordingly, when the customer makes a payment to the clerk using a card or using a fingerprint and a finger vein, the payment causes the customer to view the advertisement.

Such an advertisement system is more effective using the customer LCD display unit that is allowed to be viewed by a payer than using the LCD display unit that is used by a clerk.

As described above, by allowing the integrated biometric authentication terminal to display a customer's photo upon finger authentication before selection of financial information or in the final payment step, the customer may be worried about whether his or her own finger payments are genuine and can check his or her face using the face photo displayed through his or her finger or finger vein. Thus, it is possible to remove a psychological factor that keeps the customer insecure because he or she cannot be aware of the payment.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A wired or wireless integrated terminal having a multiple safety lock function through biometric authentication, wherein,
the integrated terminal is a point-of-sale terminal which has a cuboid shape, which has a magnetic card check unit formed on one side and an integrated circuit card check unit formed in a lower portion, which starts when a power supply unit is turned on, and which displays a payment amount on a clerk liquid crystal display (LCD) display unit through a data input unit so that a final payment button is pushed,
an electronic cover usable only by a customer is formed on a front surface opposite to the clerk LCD display unit of the POS terminal,
a customer payment system usable only by a customer who makes a payment is built in the electronic cover,
in the customer payment system, the electronic cover has a fingerprint and finger vein authentication processing unit formed on one inner side and a card information authentication processing unit formed on the other side to process a customer's card information through a near field communication transmission signal of a card to perform authentication processing with the customer's card information,
a customer LCD display unit configured to check the payment amount is formed in a central portion of the electronic cover.

2. A wired or wireless integrated biometric authentication terminal having a multiple safety lock function, wherein,
the integrated biometric authentication terminal has a cuboid shape, is separately provided for financial transactions, and is connected to a point-of-sale terminal in a wired or wireless manner,
the POS terminal has a cuboid shape, has a magnetic card check unit formed on one side and an integrated circuit card check unit formed in a lower portion, starts when a power supply unit is turned on, and displays a payment amount on a clerk LCD display unit through a data input unit so that a final payment button is pushed,
a customer payment system is formed in an electronic cover of the integrated biometric authentication terminal,
the electronic cover has at least one of a fingerprint and finger vein authentication processing unit formed on one side, as a groove on which a finger is put, to interoperate with the customer payment system of the POS terminal and a card information authentication processing unit formed on the other side to process a customer's card information through a near field communication transmission signal of a card to perform authentication processing on the payment with the customer's card information in cooperation with the customer payment system of the POS terminal,
a customer LCD display unit configured to display the payment amount is formed on an upper front end of the electronic cover.

3. The wired or wireless integrated terminal having the multiple safety lock function of claim 1, wherein the customer LCD display unit is formed on the electronic cover to execute a three-second instant advertisement video upon payment with at least one of the fingerprint and a finger vein or upon payment with a card.

4. The wired or wireless integrated biometric authentication terminal having the multiple safety lock function of claim 1, wherein a password input button for a 10-digit number is formed in an upper portion of the electronic cover and used when a password is requested.

5. The wired or wireless integrated biometric authentication terminal having the multiple safety lock function of claim 1, wherein a usage amount confirmation button is formed on the electronic cover to display a usage amount confirmation table in which transaction amounts and financial transaction approval (cancellation) numbers are accumulated.

6. The wired or wireless integrated biometric authentication terminal having the multiple safety lock function of claim 1, wherein the customer LCD display unit is formed by a hinge such that angle adjustment is possible according to a customer's location, and the electronic cover is also formed on a rear end of the main body by a hinge such that the electronic cover is rotatable along with the main body of the integrated biometric authentication terminal.

7. The wired or wireless integrated biometric authentication terminal having the multiple safety lock function of claim 1, wherein an ID photo interoperating with fingerprint and/or finger vein information is displayed on the customer LCD display unit and/or the customer LCD display unit to perform identity verification upon payment with a finger in at least one of the fingerprint and finger vein authentication processing unit.

8. The wired or wireless integrated biometric authentication terminal having the multiple safety lock function of claim 1, wherein
at least one of the fingerprint and finger vein authentication processing unit is formed as a contact-type fingerprint scan module for the purpose of fingerprint recognition and has an empty finger capture groove formed thereunder such that a finger is put on the empty finger capture groove for the purpose of finger vein recognition, and
an image sensor and an infrared transmission unit configured to capture the finger and a recognition circuit electronic unit configured to control the image sensor and the infrared transmission unit are formed in an authentication device unit space.

9. The wired or wireless integrated biometric authentication terminal having the multiple safety lock function of claim 8, wherein an optical-type recognition module is used instead of the contact-type fingerprint scan module, and the optical-type recognition module is composed of an image sensor and an infrared transmission unit to capture an image by emitting infrared rays toward a fingerprint.

10. The wired or wireless integrated biometric authentication terminal having the multiple safety lock function of claim 1, wherein,
an integrated module of the at least one of the fingerprint and finger vein authentication processing unit configured to authenticate both a fingerprint and a finger vein is composed of a fingerprint scan module, a finger vein module, and a conversion module,
the fingerprint scan module scans a fingerprint by an image sensor, compares an image obtained through the scanning to prestored images, and then outputs authentication code registered for a person corresponding to the finger image in 232 serial communication when the corresponding person is present,
the finger vein module scans a finger vein by a camera image sensor after penetrating a finger with an infrared LED, compares an image obtained through the scanning to prestored finger vein images, and then outputs authentication code registered for a person corresponding to the finger vein image in 485 serial communication when the corresponding person is present,
the conversion module receives the 485 serial communication output from the finger vein module, converts the 485 serial communication into the 232 serial communication, and outputs the 232-communication like the fingerprint module,
the integrated module receives fingerprint authentication code output from the fingerprint module and finger vein authentication code output from the finger vein module and outputs one of the fingerprint authentication code and the finger vein authentication code through Universal Serial Bus or the integrated module receives fingerprint authentication code output from the fingerprint module and finger vein authentication code output from the finger vein module and outputs corresponding authentication code through USB when the fingerprint authentication code matches the finger vein authentication code.

11. The wired or wireless integrated biometric authentication terminal having the multiple safety lock function of claim 10, wherein,
in the fingerprint scan module, GND line #1 indicates a (−) voltage circuit, RX line #2 indicates a serial data reception port, TX line #3 indicates a serial data transmission port, and VCC line #4 indicates a (+) voltage reference of a power supply circuit, and
the lines are used to scan a fingerprint by an image sensor, compare an image obtained through the scanning to prestored images, and then output authentication code registered for a person corresponding to the finger image in serial communication when the corresponding person is present.

12. The wired or wireless integrated biometric authentication terminal having the multiple safety lock function of claim 10, wherein,
in the finger vein module, GND line #1 indicates a (−) voltage reference, A line #2 indicates a serial communication specification RS485-communication port A, B line #3 indicates a serial communication specification RS485-communication port B, and VCC line #4 indicates a (+) voltage reference of a power supply circuit,
on the left side of the conversion module, GND line #1 indicates a (−) voltage reference, A line #2 indicates a serial communication specification RS485-communication port A, B line #3 indicates a serial communication specification RS485-communication port B, and VCC line #4 indicates a (+) voltage reference,
on the right side of the conversion module U4 interoperating with the finger vein module U3, DI line #5 indicates a serial 232-communication reception port, RE line #6 indicates a 485-communication control port, DE line #7 indicates a 485-communication control port, and RO line #8 indicates a serial 232-communication transmission port.

13. The wired or wireless integrated biometric authentication terminal having the multiple safety lock function of claim 1, wherein the fingerprint and finger vein authentication processing unit receives fingerprint information from the integrated biometric authentication terminal upon connection of financial information for payment performs primary user authentication using the fingerprint information, and then performs authentication processing by entering a user's phone number or processes user authentication using a user's account password, face information, or iris information when the fingerprint information is not unique and there are two pieces of the same fingerprint information.

14. The wired or wireless integrated biometric authentication terminal having the multiple safety lock function of claim 1, wherein the fingerprint and finger vein authentication processing unit comprises: a customer client connected to a communication network and configured to acquire a customer's fingerprint and/or finger vein information; an affiliate client connected to the communication network and configured to acquire the customer's fingerprint and/or finger vein information of the customer client when an e-commerce transaction occurs; and at least one of the fingerprint and finger vein payment service server configured to receive at least one of the fingerprint and finger vein information from the customer client through the communication network and register at least one of the fingerprint and finger vein information to correspond to a payment device and configured to compare at least one of the fingerprint and finger vein information received from the customer client to fingerprint and/or finger vein information transmitted from the affiliate client upon the transmission of at least one of the fingerprint and finger vein information from the affiliate client, perform authentication processing of the customer, and perform a payment through the payment device corresponding to at least one of the fingerprint and finger vein information of the customer client.

15. The wired or wireless integrated biometric authentication terminal having the multiple safety lock function of claim 14, wherein when a result of comparing the registered fingerprint information of the customer client to newly received fingerprint information upon connection of financial information for payment through the communication network is that the fingerprint information is not unique and there are two pieces of the same fingerprint information, authentication processing is performed by entering one of a user's phone number or a password, one piece of the financial information for payment is selected for the user, and then secondary user authentication is processed using face information.

16. The wired or wireless integrated terminal having the multiple safety lock function of claim 1, wherein an iris information authentication processing unit and/or a face information authentication processing unit are formed in an upper central portion of the customer LCD display unit.

17. An advertisement method using a wired or wireless integrated terminal having a multiple safety lock function associated with an advertisement, wherein the advertisement method is an advertisement method using a point-of-sale terminal that has a customer liquid crystal display unit formed on an electronic cover formed on a front surface of the POS terminal and that executes a three-second instant advertisement video upon payment with at least one of the fingerprint and a finger vein or upon payment with a card, the advertisement method comprising: a step of turning on an advertisement switch of the POS terminal; a thirty-second advertisement video step in which a general thirty-second short advertisement video is displayed on the customer LCD display unit when the advertisement switch of the POS terminal is turned on; a payment amount input step in which a payment amount is entered and then displayed on the customer LCD display unit; a step of stopping the advertisement and displaying the payment on the customer LCD display unit when the payment amount is entered; a payment amount informing step in which a customer is informed of payment methods using a voice (or text); a payment execution step in which the customer selects a payment method (human body information or card information); an advertisement execution step in which when a charged amount is paid, a three-second instant advertisement is executed; and a payment completion step in which the payment is entirely complete after a three-second instant advertisement is executed.

18. The advertisement method of claim 17, further comprising, after the advertisement execution step in which a three-second instant advertisement is executed, an advertisement video repeating step in which the three-second instant advertisement video is further executed when the customer touches the human body information or the card information once more.
